(19) United States
(12) Patent Application Publication
(10) Pub. No.: US 2023/0370439 A1
(43) Pub. Date: Nov. 16, 2023

(54) NETWORK ACTION CLASSIFICATION AND ANALYSIS USING WIDELY DISTRIBUTED HONEYPOT SENSOR NODES

(71) Applicant: QOMPLX, Inc., Tysons, VA (US)

(72) Inventors: Jason Crabtree, Vienna, VA (US); Richard Kelley, Woodbridge, VA (US)

(21) Appl. No.: 18/361,835

(22) Filed: Jul. 29, 2023

Related U.S. Application Data
(63) Continuation-in-part of application No. 18/336,873, filed on Jun. 16, 2023.
Application No. 18/336,873 is a continuation-in-part of application No. 18/297,500, filed on Apr. 7, 2023.
Application No. 18/297,500 is a continuation-in-part of application No. 18/169,203, filed on Feb. 14, 2023.
Application No. 18/169,203 is a continuation-in-part of application No. 17/245,162, filed on Apr. 30, 2021, now Pat. No. 11,582,207.
Application No. 17/245,162 is a continuation of application No. 15/837,845, filed on Dec. 11, 2017, now Pat. No. 11,005,824.
Application No. 15/837,845 is a continuation-in-part of application No. 15/825,350, filed on Nov. 29, 2017, now Pat. No. 10,594,714.
Application No. 15/825,350 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 15/655,113 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
(60) Provisional application No. 62/596,105, filed on Dec. 7, 2017.

(51) Int. Cl. H04L 9/40; H04L 9/32

(52) U.S. Cl. CPC H04L 63/0428; H04L 63/1433; H04L 9/3236; H04L 63/1425; H04L 63/145; H04L 63/0807; H04L 9/3239; H04L 63/0815

(57) ABSTRACT

A system and methods for network action classification and analysis using widely distributed lightweight honeypot sensor nodes, comprising a plurality of network traffic sensors each configured to monitor visible network traffic, analyze monitored traffic to identify patterns, communicate with other network sensors to correlate their respective traffic data, and produce a threat landscape based on the correlated traffic data. The system and method may comprise an emulation engine configured to simulate limited services or functionalities, emulating vulnerabilities or weak points in systems. Emulation engine may comprise one or more modules configured to provide use-case specific emulation capabilities. Emulation engine may receive network traffic data from network sensors, route the network traffic to an appropriate simulated destination service associated with the network traffic, and monitor the interactions between an attacker and the simulated destination. Logged interactions may be used as an input to generate the threat landscape.

### CROSS-REFERENCE TO RELATED APPLICATIONS

Priority is claimed in the application data sheet to the following patents or patent applications, each of which is expressly incorporated herein by reference in its entirety:
Ser. No. 18/336,873
Ser. No. 18/297,500
Ser. No. 18/169,203
Ser. No. 17/245,162
Ser. No. 15/837,845
Ser. No. 62/596,105
Ser. No. 15/825,350
Ser. No. 15/725,274
Ser. No. 15/655,113
Ser. No. 15/616,427
Ser. No. 14/925,974
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536

### BACKGROUND OF THE INVENTION

### Field of the Invention

The disclosure relates to the field of cybersecurity and observability, and is particularly pertinent to the use of a network of widely distributed sensor nodes to classify traffic and actions from both human and artificial agents and identify potential threats, broader health and utilization information and trends from network, security, observability, and application telemetry.

### Discussion of the State of the Art

Log management, Security Information and Event Management (STEM) tools and increasingly cyber data lakes aggregate large volumes of data, generate huge volumes of alerts, and often overwhelms limited staff resources which must interpret this morass of information. which makes noise reduction a tedious and costly problem. For perimeter security device telemetry and associated alerts, cross referencing IP addresses observed in perimeter logs with classified traffic and risk information can filter out any source that isn't a threat. SOC analysts have a lot to keep them busy, they don't need to spend time investigating a security researcher or attack surface management or vuln scanning company that doesn't pose any threat. Normal course internet scanning is not a “threat” or “attack” per se. After appropriately attributed and benign signals are removed there are two things that can be ascertained for any given residual signal from Internet-facing scanning: whether an attacker is looking at the entire internet, or is targeting a particular network or resource specifically, and whether an attacker that is targeting a specific network or resource poses a greater threat than broad activity. When such information is viewed across multiple entities, e.g., financial institutions, additional information re: sector specific or geographic targeting may also be deduced or inferred. Extending this, by monitoring the live activity of the web it can be treated like a weather report (especially when combined with both extrapolative forecasting from statistical or ML-based methods along with simulation based approaches) and used to give advance warning, giving the opportunity to take defensive actions before an attack happens.

What is needed is a system that uses distributed sensor nodes to monitor and aggregate varied Internet traffic alongside a system capable of aggregating, analyzing, simulating and forecasting scanning and general utilization to identify aberrations, trends, and patterns in support of ultimately surfacing changing operational dynamics and risks, ultimately incorporating that information into tool-specific network security policies, which includes the ability to update network defense devices in real-time such as firewall configurations or endpoint device signatures or DNS sinkholes or microsegmentation services (e.g. Illumio) or hypervisor/virtualized infrastructure (e.g. VMWare, AWS or Azure infrastructure, or Nutanix), to aid in filtering and analyzing traffic and threat identification during and in advance of an actual attack or operational disruption.

### SUMMARY OF THE INVENTION

Accordingly, the inventor has conceived, and reduced to practice, a system and methods for network action classification and analysis using widely distributed lightweight honeypot sensor nodes, comprising a plurality of network traffic sensors each configured to monitor visible network traffic, analyze monitored traffic to identify patterns, communicate with other network sensors to correlate their respective traffic data, and produce a threat landscape based on the correlated traffic data. The system and method may comprise an emulation engine configured to simulate limited services or functionalities, emulating vulnerabilities or weak points in systems. Emulation engine may comprise one or more modules configured to provide use-case specific emulation capabilities. Emulation engine may receive network traffic data from network sensors, route the network traffic to an appropriate simulated destination service associated with the network traffic, and monitor the interactions between an attacker and the simulated destination. Logged interactions may be used as an input to generate the threat landscape.

In one aspect of the invention, for deception-based cybersecurity using distributed sensor nodes is disclosed, comprising: a plurality of network traffic sensors each comprising a plurality of programming instructions stored in a memory of, and operating on a processor of, a respective computing device, wherein each plurality of programmable instructions, when operating on the processor, cause the respective computing device to: monitor visible network traffic; analyze the traffic to identify a plurality of patterns, wherein the analysis comprises analysis of a plurality of network interactions, commands executed, and attempted exploits; communicate with at least one other of the plurality of network traffic sensors to correlate the identified plurality of patterns with the respective identified patterns of the at least one other network traffic sensor; produce a threat landscape, wherein the threat landscape comprises a plurality of identified traffic patterns; identify a plurality of potential cybersecurity threats based on the threat landscape; and export the analyzed traffic data and the threat landscape for use by external systems.

In another aspect of the invention, a method for deception-based cybersecurity using distributed sensor nodes is disclosed, comprising the steps of: monitoring, at a network traffic sensor, visible network traffic; analyzing the traffic to identify a plurality of patterns, wherein the analysis comprises analysis of a plurality of network interactions, commands executed, and attempted exploits; communicating with at least one other of the plurality of network traffic sensors to correlate the identified plurality of patterns with the respective identified patterns of the at least one other network traffic sensor; producing a threat landscape, wherein the threat landscape comprises a plurality of identified traffic patterns; identifying a plurality of potential cybersecurity threats based on the threat landscape; and exporting the analyzed traffic data and the threat landscape for use by external systems.

According to an aspect of an embodiment, a network module comprising a second plurality of programming instructions stored in the memory of, and operating on the processor of, the respective computing device, wherein the second plurality of programmable instructions, when operating on the processor, cause the respective computing device to: receive the traffic, the traffic being associated with a network service; analyze the traffic to determine a destination network service associated with the traffic; emulate the destination network service and forward the traffic to the emulated destination network service; and monitor and log the network interactions.

According to an aspect of an embodiment, a web module comprising a third plurality of programming instructions stored in the memory of, and operating on the processor of, the respective computing device, wherein the third plurality of programmable instructions, when operating on the processor, cause the respective computing device to: receive the traffic, the traffic being associated with a web service; analyze the traffic to determine a destination web service associated with the traffic; emulate the destination web service and forward the traffic to the emulated destination web service; and monitor and log web interaction data.

According to an aspect of an embodiment, an internet-of-things module comprising a fourth plurality of programming instructions stored in the memory of, and operating on the processor of, the respective computing device, wherein the fourth plurality of programmable instructions, when operating on the processor, cause the respective computing device to: connect to an Internet-of-Things (IoT) device; determine an IoT protocol or service associated with the IoT device; emulate the IoT protocol or service; and monitor and log commands executed and exploits attempted within the emulation.

According to an aspect of an embodiment, a vulnerability module comprising a fifth plurality of programming instructions stored in the memory of, and operating on the processor of, the respective computing device, wherein the fifth plurality of programmable instructions, when operating on the processor, cause the respective computing device to: simulate a known vulnerability or weakness to attract an attacker; receive the traffic, the traffic being associated with the attacker or abuser; and monitor and log commands, system information, network interactions, OS interactions, or application information associated both directly or indirectly with executed exploits attempted by the attacker as the attacker interacts with simulated vulnerability or weakness. This can include successful exploits and unsuccessful attempts—e.g. via monitoring and analyzing crash dumps for Windows (e.g. via WER and WQL) or Linux (e.g. via minidumps). Additional insights into According to an aspect of an embodiment, the plurality of network interactions, commands executed, and attempted exploits are received from an emulation engine, the emulation engine comprising one or more modules configured to operate as a lightweight honeypot.

According to an aspect of an embodiment, the plurality of network interactions, commands executed, and attempted exploits are logged during monitored interactions between an attacker and an emulated service or emulated application.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1A is a diagram of an exemplary architecture of an advanced cyber decision platform according to one aspect.

FIG. 1B is a diagram showing a typical operation of accessing a service provider that relies on the SAML protocol for authentication.

FIG. 1C is a diagram showing a method of cyberattack using a forged AO 140, which may also be referred to as a “golden SAML” attack.

FIG. 2 is a block diagram illustrating an exemplary system architecture for a system for detecting and mitigating forged authentication object attacks according to various embodiments of the invention.

FIG. 3A is a flow diagram of an exemplary function of the business operating system in the detection and mitigation of predetermining factors leading to and steps to mitigate ongoing cyberattacks.

FIG. 3B is a process diagram showing a general flow of the process used to detect rogue devices and analyze them for threats.

FIG. 3C is a process diagram showing a general flow of the process used to detect and prevent privilege escalation attacks on a network.

FIG. 3D is a process diagram showing a general flow of the process used to manage vulnerabilities associated with patches to network software.

FIGS. 4A and 4B are process diagrams showing business operating system functions in use to mitigate cyberattacks.

FIG. 5 is a process flow diagram of a method for segmenting cyberattack information to appropriate corporation parties.

FIG. 6 is a diagram of an exemplary architecture for a system for rapid predictive analysis of very large data sets using an actor-driven distributed computational graph, according to one aspect.

FIG. 7 is a diagram of an exemplary architecture for a system for rapid predictive analysis of very large data sets using an actor-driven distributed computational graph, according to one aspect.

FIG. 8 is a diagram of an exemplary architecture for a system for rapid predictive analysis of very large data sets using an actor-driven distributed computational graph, according to one aspect.

FIG. 9 is a diagram of an exemplary architecture for a user and entity behavioral analysis system, according to one aspect.

FIG. 10 is a flow diagram of an exemplary method for cybersecurity behavioral analytics, according to one aspect.

FIG. 11 is a flow diagram of an exemplary method for measuring the effects of cybersecurity attacks, according to one aspect.

FIG. 12 is a flow diagram of an exemplary method for continuous cybersecurity monitoring and exploration, according to one aspect.

FIG. 13 is a flow diagram of an exemplary method for mapping a cyber-physical system graph (CPG), according to one aspect.

FIG. 14 is a flow diagram of an exemplary method for continuous network resilience scoring, according to one aspect.

FIG. 15 is a flow diagram of an exemplary method for cybersecurity privilege oversight, according to one aspect.

FIG. 16 is a flow diagram of an exemplary method for cybersecurity risk management, according to one aspect.

FIG. 17 is a flow diagram of an exemplary method for mitigating compromised credential threats, according to one aspect.

FIG. 18 is a flow diagram of an exemplary method for dynamic network and rogue device discovery, according to one aspect.

FIG. 19 is a flow diagram of an exemplary method for Kerberos “golden ticket” attack and “golden SAML” attack detection, according to one aspect.

FIG. 20 is a flow diagram of an exemplary method for risk-based vulnerability and patch management, according to one aspect.

FIG. 21 is a flow diagram of an exemplary method for establishing groups of users according to one aspect.

FIG. 22 is a flow diagram of an exemplary method for monitoring groups for anomalous behavior, according to one aspect.

FIG. 23 is a flow diagram for an exemplary method for handing a detection of anomalous behavior, according to one aspect.

FIG. 24 is a flow diagram illustrating an exemplary method for processing a new user connection, according to one aspect.

FIG. 25 is a flow diagram illustrating an exemplary method for verifying the authenticity of an authentication object, according to one aspect.

FIG. 26 is a flow diagram illustrating an exemplary method for generating an authentication hash-print for a new user, according to one aspect.

FIG. 27 is a flow diagram illustrating an exemplary method for passively authenticating a user using a stored authentication hash-print as a fallback when an identity provider is unavailable, according to one aspect.

FIG. 28 is a flow diagram illustrating an exemplary method for verifying a user session based on a randomly-selected subset of authentication characteristics to prevent forgery, according to one aspect.

FIG. 29 is a block diagram illustrating the deployment of distributed sensor nodes at various Internet-connected locations, according to one aspect.

FIG. 30 is a flow diagram illustrating an exemplary method for using distributed sensor nodes to classify Internet traffic and identify risks, according to one aspect.

FIG. 31 is a flow diagram illustrating an exemplary process for signal filtering using distributed sensor nodes, according to one aspect.

FIG. 32 is a block diagram illustrating an exemplary system architecture for system of distributed sensor nodes configured to provide lightweight honeypot capabilities, according to an embodiment.

FIG. 33 is a block diagram illustrating an exemplary embodiment of a system of distributed sensor nodes configured to provide lightweight honeypot capabilities utilizing an emulation cloud configured to provide high-interactive honeypot functionality, according to an embodiment.

FIG. 34 is a flow diagram illustrating an exemplary method for gathering network interaction data, according to an embodiment.

FIG. 35 is a flow diagram illustrating an exemplary method for gathering web interaction data, according to an embodiment.

FIG. 36 is a flow diagram illustrating an exemplary method for gathering command and vulnerability exploit data, according to an embodiment.

FIG. 37 is a flow diagram illustrating an exemplary method for gathering IoT reconnaissance data, according to an embodiment.

FIG. 38 illustrates an exemplary computing environment on which an embodiment described herein may be implemented, in full or in part.

### DETAILED DESCRIPTION OF THE INVENTION

The inventor has conceived, and reduced to practice, a system and methods for network action classification and analysis using widely distributed lightweight honeypot sensor nodes, comprising a plurality of network traffic sensors each configured to monitor visible network traffic, analyze monitored traffic to identify patterns, communicate with other network sensors to correlate their respective traffic data, and produce a threat landscape based on the correlated traffic data. The system and method may comprise an emulation engine configured to simulate limited services or functionalities, emulating vulnerabilities or weak points in systems. Emulation engine may comprise one or more modules configured to provide use-case specific emulation capabilities. Emulation engine may receive network traffic data from network sensors, route the network traffic to an appropriate simulated destination service associated with the network traffic, and monitor the interactions between an attacker and the simulated destination. Logged interactions may be used as an input to generate the threat landscape.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall”, “DOB 08/13/1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context”, as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

A “pipeline”, as used herein and interchangeably referred to as a “data pipeline” or a “processing pipeline”, refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

### Conceptual Architecture

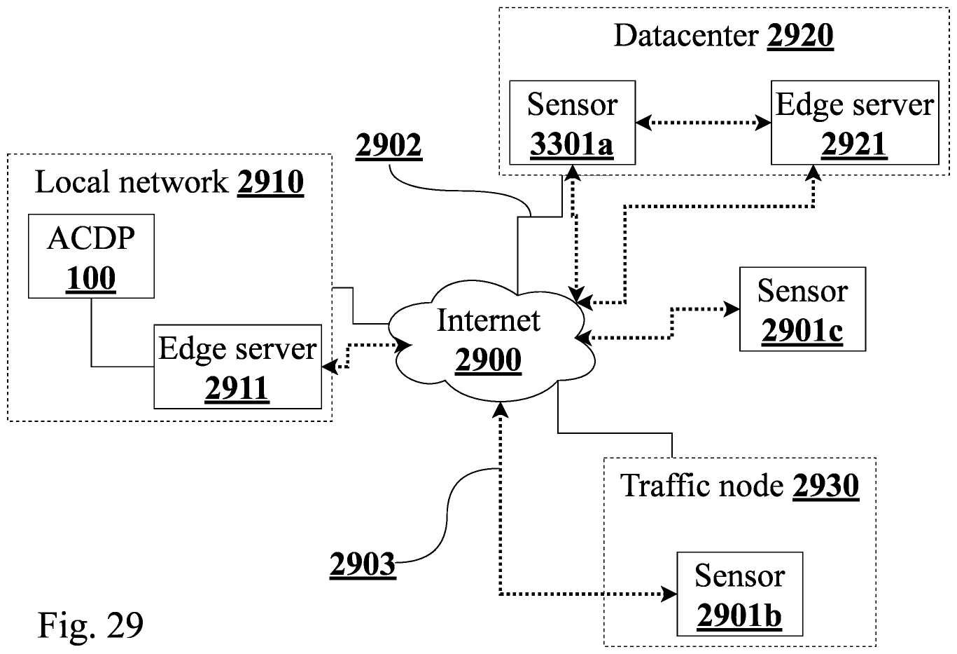

FIG. 29 is a block diagram illustrating the deployment of distributed sensor nodes at various Internet-connected locations, according to one aspect. The use of distributed sensor nodes enables monitoring of Internet traffic at various geographic points through which it passes, such as datacenters and other traffic nodes. The sensors themselves may also operate as a form of “shallow honeypot”, wherein traffic is monitored and analyzed, and various services may be operated in a safe environment such as a virtualized sandbox, but no reactive action is necessarily taken if a potential attack is detected at a service. This enables the classification of traffic, for example according to source or destination, which in turn enables more complex analysis and classification to identify potential risks as well as to whitelist known-benign traffic such as that which originates from known safe domains, or that which is destined for safe services or resources rather than those which may pose a risk. The use of lightweight honeypot-style analysis further enables the correlation of traffic data with vulnerabilities, probing attempts, or attempted attacks against various services, enabling the identification of suspicious or malicious traffic, domains, and addresses without alerting attackers. This enables observation of what a potential attacker may be interested in (for example, specific networks or targeted services), which when correlated with other traffic patterns and data from other sensors can be used to form a “threat landscape” that reveals attacker motivations alongside the patterns and correlations identified in suspicious or malicious traffic.

As illustrated, a plurality of sensor nodes 2901a-c may be installed and operated as part of Internet-connected locations such as (for example, including but not limited to) a datacenter 2920 or traffic node 2930 such as a DNS resolver, cable termination station (where submarine communication cables carrying Internet traffic connect to the land-based network infrastructure), Internet service provider (ISP) facility, a virtual private network (VPN) server, or other network infrastructure. A sensor may also optionally be deployed in a standalone configuration 2901c, where it may operate as a server connected directly to the Internet 2900 without being part of a larger installation, for example for use as a shallow honeypot running various network-connected services or applications to monitor for attempted probes or attacks. These sensors may then communicate 2903 with each other via the Internet 2900, forming a network of distributed nodes where each individual sensor's information may be shared with others to aggregate traffic data for improved analysis. For example, a sensor 2901a installed in a datacenter 2920 may monitor and analyze traffic 2902 that flows through the datacenter 2920, such as (for example, including but not limited to) web traffic from users, database queries from other datacenter locations, administrative access from outside the network where the sensor resides, or any other traffic that may originate from, or be received by, the datacenter's network where the sensor is located. This information may be logged and provided to other sensor nodes 2903 so that sensors in other locations may benefit from the traffic information they may not be able to directly observe, such that each individual sensor contributes its own contextual information to form a more complete analysis of Internet traffic as a whole.

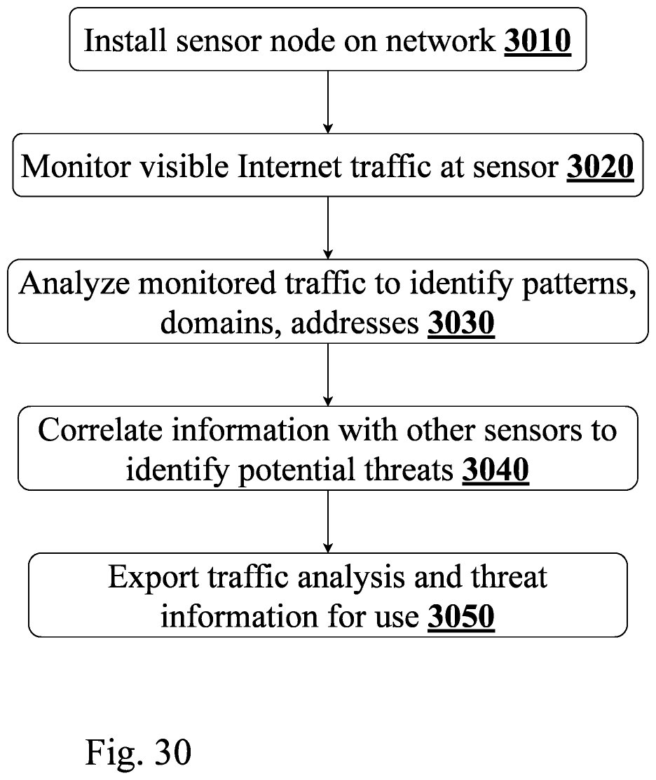

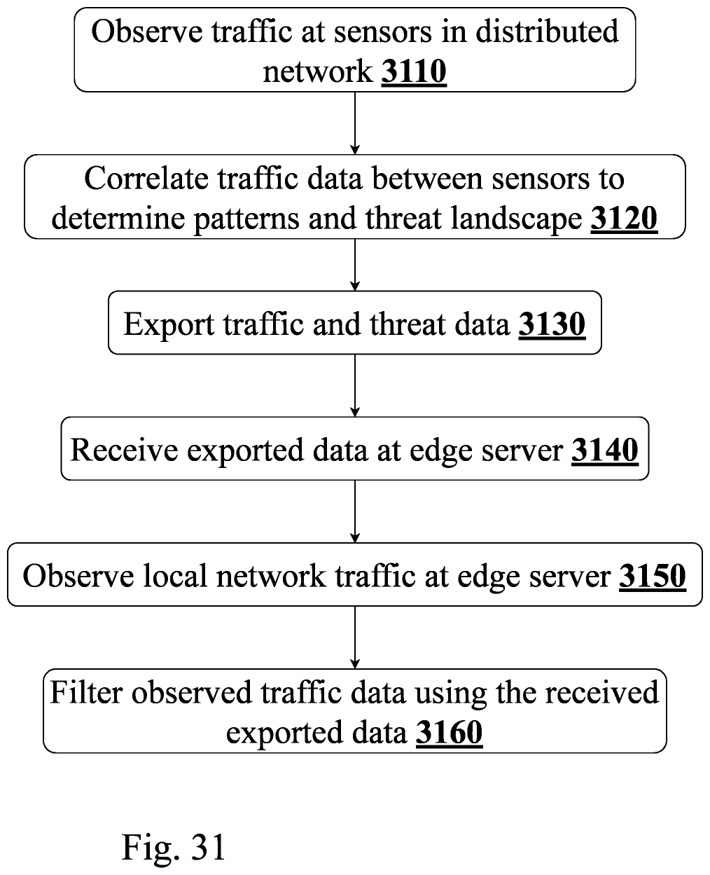

Information from a network of distributed sensors may then be utilized by an edge server 2911 operating as part of a local network 2910, for example a home network running a firewall or intrusion detection server (IDS), or a datacenter that may utilize the sensor network information such as in a subscription-based SaaS model where the operator of the datacenter pays for access to the network's traffic information. Data from edge server 2911 may be provided to an advanced cyber-decision platform (ACDP) 100 for various purposes, such as (for example, including but not limited to) dynamically updating security policies, managing user credentials, maintaining entries in a Kerberos domain controller or identity provider, enforcement of privilege assurance, or any of a variety of other operations that may be performed using an ACDP and for which traffic and threat information may be pertinent (many examples of which are described in detail below with reference to various figures). Additionally, such an edge server may be operated concurrently with a sensor node, as shown in datacenter 2920 which operates both an on-site sensor 2901a and an edge server 2921 that benefits from the traffic information gathered by the sensor network. In such an arrangement, traffic information may be received by edge server 2911 directly from an on-site sensor 2901a as well as from the greater sensor network 2903, to combine the benefits of the “big picture” analysis of traffic information from the distributed nodes as well as the rapid response time and datacenter-specific context sensitivity of receiving traffic information directly from the locally-operated sensor 2901a. Edge servers 2911, 2921 may utilize traffic information in a variety of ways, such as (for example, including but not limited to) filtering or de-noising traffic at a firewall or other edge device or service based on patterns observed or derived by a network of distributed sensors (described below with reference to FIG. 30), or dynamically updating security policies based on traffic classification and threat identification (described below, with reference to FIG. 31).

FIG. 30 is a flow diagram illustrating an exemplary method for using distributed sensor nodes to classify Internet traffic and identify risks, according to one aspect. When a sensor node 2901a-c is installed on a network 3010, it may be configured to have visibility into, and to monitor, Internet traffic at the network's edge 3020, such as web requests, access logins, port scans, ping or other ICMP requests, or other traffic. This monitored traffic may then be analyzed 3030 to identify traffic patterns as well as associate various traffic with domains or addresses from which it originated or through which it is flowing, such as proxy servers, relays, or VPN connections that may “hop” through various servers and networking nodes before reaching a destination, and to build records of observed events, event types, and patterns that may be stored for future use (for example, to perform new analysis using historical data, or for training of machine learning models using batches of logged traffic data as training input sets). This analyzed traffic information can then be relayed 3040 to other sensor nodes via the Internet 2900, so that multiple sensors' traffic data can be correlated to identify broader patterns and identify potential threats such as domains associated with suspicious or malicious traffic. For example, traffic across multiple locations can be analyzed to identify common domains or requests, which may indicate patterns of suspicious behavior that can be used to develop a “threat landscape” that can be employed to proactively identify risky traffic as it is observed by maintaining knowledge of identified risky traffic and its connections to various hosts, domains, and locations that are observed by sensors in the distributed network. This traffic and threat data can then be exported 3050 for use by other systems or networks, for example for use in signal filtering at an edge server as described below in FIG. 31, or for incorporation into processing by an ACDP 100 for use in enhancing security policies or enforcing privilege assurance, as described in detail below.

FIG. 31 is a flow diagram illustrating an exemplary process for signal filtering using distributed sensor nodes, according to one aspect. According to this process, Internet traffic may be observed at various sensors 2901a-c installed as components of a distributed sensor network 3110. This traffic information may then be correlated between multiple sensors 3120, to identify traffic patterns such as correlations between requests, source or destination addresses or domains, geographic locale, time or date, or other details that may be observed and correlated. This correlation may also be used to develop a threat landscape, identifying suspicious or malicious traffic and correlating it with sources, destinations, targeted services or providers, or other such correlations that be useful when detecting or identifying potentially-malicious traffic. The correlated data may then be exported 3130 for use by external systems or services, for example by an edge server 2911 that may receive the exported data 3140 for use in signal filtering observed traffic at a local network. As the edge server monitors local traffic 3150, the traffic information may be filtered 3160 using the exported data from the distributed sensor network to reduce noise and focus on pertinent traffic such as potential cyberattacks or indicators of a possible future attack. For example, unimportant traffic may be discarded from logs or excluded from reporting in order to improve the signal-to-noise ratio of the information contained in logs or reports, and security administrators may focus on the information that is more pertinent to their goals.

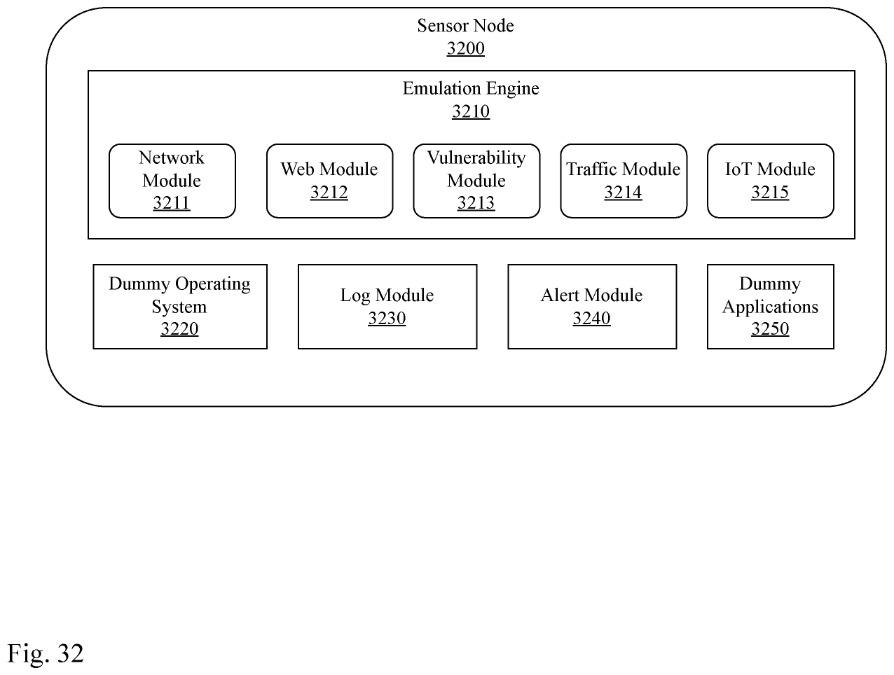

FIG. 32 is a block diagram illustrating an exemplary system architecture for system of distributed sensor nodes configured to provide lightweight honeypot capabilities, according to an embodiment. According to the embodiment, the system comprises a plurality of distributed sensors nodes, such as the sensor node network 2903 or any other sensor node that may or may not be described herein. Sensor node 3200 may be configured to operate as a lightweight honeypot that can simulate limited services or functionalities, emulating vulnerabilities or weak points in systems. It can provide basic interaction with attackers, capturing information while minimizing potential risks.

Sensor node 3200 can be deployed at various points within an organization's network architecture. A sensor node 3200 may be external-facing and exposed to the Internet, attracting attackers scanning for vulnerable targets. A sensor node 3200 may be internal-facing wherein it is placed within internal network segments, designed to detect and analyze attacks originating from within the organization. Because of the distributed nature of the sensor network and the data sharing capabilities between and among each sensor node, the system can facilitate a hybrid combination of external-facing and internal-facing lightweight honeypots, providing a comprehensive view of both external and internal threats.

According to the embodiment, sensor node 3200 comprises an emulation engine 3210 configured to simulate various systems, services, and/or processes in order to entice potential attackers or intruders to interact with sensor node 3200. Emulation engine 3210 may comprise one or more modules configured to provide use-case specific emulation capabilities. Emulation engine and/or the modules may receive, retrieve, otherwise obtain network traffic data which is being monitored by sensor node 3200. Emulation engine 3210 may analyze the network traffic to determine a destination service or process in which the network traffic is associated with, and then forwarding the network traffic to the appropriate module associated with the destination. The present embodiment comprises a network module 3211, a web module 3212, a vulnerability module 3213, a traffic module 3214, and an Internet-of-Things (IoT) module 3215. Network module 3211 may provide functionality for simulating (i.e., emulating) various network services, such as, for example (and not limiting) Simple Network Time Protocol (SNTP) (e.g., responding to time synchronization requests), Domain Name System (DNS) (e.g., emulating DNS server functionality, responding to DNS queries), File Transfer Protocol (FTP) (e.g., simulating an FTP server, responding to basic commands), and Telnet or Secure Shell (SSH) (e.g., emulating remote terminal access, capturing login attempts and commands). Information gathered via network module 3211, and any analysis thereof, may be used by sensor node 3200 as an input when generating and/or updating a threat landscape.

A web module 3212 may be configured to simulate basic web services and applications such as, for example (and not limiting) web servers (e.g., responding to HTTP requests, emulating common server software like Apache of Microsoft IIS), Content Management Systems (CMS) (e.g., simulating popular CMS platforms like WordPress or Joomla, attracting attacks targeting known vulnerabilities), and web forms (e.g., presenting forms that mimic login pages, contact forms, or other web-based interactions to capture submitted data). Information gathered via web module 3212, and any analysis thereof, may be used by sensor node 3200 as an input when generating and/or updating a threat landscape.

Vulnerability module 3213 can provide simulated vulnerabilities or weaknesses to attract attackers exploiting known issues. Sensor node 3200 can be configured with specific vulnerabilities or services to attract attackers. Some examples include, presenting seemingly valid usernames and passwords to entice attackers to attempt unauthorized access, simulating misconfigured services or outdated software versions that attackers typically target, and providing enticing dummy data that appears valuable to attackers, such as fake financial records, user credentials, or sensitive documents. By analyzing the attack signatures, such as the sequence of commands or payload characteristics, sensor node 3200 can identify common attack patterns or attempted exploits used by different attackers or attacker groups. Information gathered via vulnerability module 3213, and any analysis thereof, may be used by sensor node 3200 as an input when generating and/or updating a threat landscape.

A traffic module 3214 may be configured to periodically generate and transmit simulated traffic from a sensor node to one or more other sensor nodes. The simulated traffic may be used to entice malicious actors to investigate the sensor node receiving the simulated traffic, luring the potential attacker to engage with the sensor node configured to operate as a lightweight honeypot. In some implementations, the use of simulated traffic may be used to direct attackers running network sniffers to the sensor node receiving the simulated traffic in order to identify or otherwise detect the network sniffer. For example, simulated traffic may comprise simulated authentication information (e.g., username/password combinations) to network services (real or dummy) located on the sensor node. Simulated traffic may be used for any protocol in which a username/password combinations are sent (e.g., telnet, pop3, FTP, and/or the like). Information gathered via traffic module 3214, and any analysis thereof, may be used by sensor node 3200 as an input when generating and/or updating a threat landscape.

These are only exemplary modules that may be used in various implementations of the disclosed system and do not represent the full scope of modules that may be deployed. Other types of modules may be developed and deployed by emulation engine based on the use case and/or embodiment or organizational goals/requirements.

Sensor node 3200 may further comprise a dummy operating system (OS) 3220 and one or more dummy applications 3250 which function deceive attackers and gather information about their techniques, tactics, and behaviors. The purpose of dummy operating system 3220 within sensor node 3200 is to mimic a real operating system, making it appear genuine and attractive to potential attackers. It mimics the appearance, behavior, and vulnerabilities of a specific operating system, making it difficult for attackers to distinguish it from a legitimate system. By emulating a genuine operating system, a dummy operating system within a honeypot can lure attackers into interacting with it. Attackers may attempt to exploit vulnerabilities, execute malicious activities, or deploy their tools and malware, believing they are targeting a real system. The activity (e.g., commands executed, files accessed or modified, network connections established, or other relevant information) of an attacker within a dummy OS can be captured and logged by sensor node 3200 and used to provide a rich contextual data about a network or organization's threat landscape. This contextual information can be shared/compared between and among the plurality of distributed sensor nodes to form a shared knowledge of potential attackers and their methodologies. In some aspects, sensor node 3200 and/or emulation engine 3210 may comprise a plurality of container images of distinct types of vulnerable services/applications. The containers are lightweight, isolated environments that package an application (or service) and its dependencies, allowing it to run consistently across different computing environments. Dummy applications 3250 function similarly to dummy OS 3220 by providing emulated applications which can be used to gather reconnaissance information about a potential attacker.

The information gathered from sensor node 3200 can significantly contribute to incident response and threat intelligence efforts. Sensor node 3200 can serve as early warning systems, detecting attacks in their early stages, and providing valuable alerts to security teams. Sensor nodes 3200 capture detailed information about the tactics, techniques, and procedures (TTPs) employed by attackers. This data helps improve understanding of attack methodologies, patterns, and trends. Information gathered from sensor node 3200 can aid in the development of signatures and detection rules to identify and block similar attacks in the future. This information can contribute to the production of a threat landscape.

In some implementations, contextual information (and various other data collected by sensor node 3200) may be processed or otherwise transformed prior to storage. In some implementations, the contextual information may be vectorized and stored in vector data, wherein the stored vector data may be used as inputs to or to develop one or more machine learning algorithms configured to analyze attack methodologies, identify and classify emerging threats, and develop effective countermeasures.

Sensor node 3200 may further comprise a log module 3230 configured to capture essential information about attacker activities for analysis and threat intelligence (i.e., informing and developing a threat landscape associated with a network/organization). Logs can encompass various types of information, including network traffic logs, command logs, system logs, and application logs. Network traffic logs record all incoming and outgoing network communication, providing insights into the connections made by attackers. Command logs capture the commands executed by attackers within the honeypot environment, revealing their actions and intentions. System logs detail system-level activities and events, while application logs focus on specific applications or services running within the sensor node 3200 and/or emulation engine 3210. Log module 3230 may monitor and collect connection metadata such as, for example, recording IP addresses, connection timestamps, and geolocation of the attacker. Log module 3230 may further collect commands and interactions such as, for example, logging commands, requests, and responses exchanged between sensor node 3200 and the attacker. Information related to user-agent identification may be collected including details about the attacker's user agent, operating system, or tools used. Information gathered by log module 3230 may be parsed and analyzed and used to contribute to the production of a threat landscape.

Log parsing involves extracting structured information from the raw log data. Parsing may be performed using log analysis tools or scripts that can interpret log formats and extract relevant fields such as timestamps, source IP addresses, targeted URLs, executed commands, or error codes. Effective log parsing enables easier analysis and correlation of different log entries. In some embodiments, various log information and/or network traffic may be analyzed by sensor node 3200 to identify a plurality of patterns, wherein the analysis can include, but is not limited to, analysis of a plurality of network interactions, commands executed, and/or attempted exploits by a potential attacker/intruder. Sensor node 3200 may communicate with any number of other sensor nodes in the distributed sensor node network to correlate the identified patterns with respective identified patterns of at least one other sensor node. The identified and correlated plurality of patterns may then be used as an input to generate and/or update a threat landscape associated with a network and/or organization.

Sensor nodes generate a vast amount of log data, especially when multiple sensor nodes are deployed. Correlating and aggregating logs from different sensor nodes helps identify patterns that may span across multiple instances. By combining logs, analysts can gain a broader view of attacker activities, recognize coordinated attacks, and identify patterns that may be missed when examining individual logs in isolation. In some embodiments, these patterns might include specific attack signatures, recurring IP addresses or ranges, common attack vectors, or known exploit attempts. Identifying such patterns helps build threat intelligence, detect future attacks, and strengthen overall cybersecurity defenses. It is important to note that log analysis is an iterative and ongoing process. As new logs are generated and more data is collected over time, the analysis should be continuously updated to adapt to evolving attacker techniques and patterns. Additionally, incorporating threat intelligence from external sources can provide valuable context and enhance the effectiveness of log analysis for identifying patterns in attackers' behavior.

While attribution in the cybersecurity domain is challenging, analyzing sensor node 3200 logs collectively may reveal clues about the attackers' motivations, targets, or affiliations. By examining patterns across multiple sensor nodes and correlating with external threat intelligence sources, it may be possible to gain insights into the broader context and potentially attribute attacks to specific threat actors or groups.

Data collected or processed by sensor node 3200 may be stored locally in a suitable data storage device. In some embodiments, sensor node 3200 may transmit data to an edge server for storage and/or processing. In some embodiments, a cloud service may be provided which can integrate with sensor nodes to provide large scale high-interactive honeypot farm support and functionality.

According to some embodiments, machine learning and/or artificial intelligence models configured for anomaly detection may be developed based at least in part on the identified patterns discussed herein, or which may otherwise be identified. Applying machine learning techniques to sensor node logs can help identify anomalous behavior and patterns that may be indicative of attacks. By training models on normal activity data and comparing the observed behavior against the learned patterns, it is possible to detect and classify attacks based on their distinct patterns.

Sensor node 3200 may further be configured to discover, connect to, and communicate with Internet-of-Things (IoT) devices, which may or may not represent a potential attacker or intruder or otherwise malicious actor. IoT devices usually open network ports to permit interaction between the physical and virtual worlds. The number of interconnected devices is already estimated to be five billion and rapidly expanding. Millions of these IoT devices are exposed on the Internet without proper protection. Therefore, IoT devices represent a potential path for system/network compromise and/or vulnerability, to both security professionals and attackers, alike.

An IoT module 3215 may be implemented which can emulate specific IoT services or protocols that are known to have vulnerabilities. By exposing these emulated services to the network, sensor node 3200 can attract potential attackers targeting those vulnerabilities. The interactions between sensor node 3200 and the attacker can provide insights into the attacker's techniques, the specific vulnerabilities being exploited, and potential compromise indicators. In some implementations, sensor nodes 3200 can emulate IoT devices themselves, mimicking their behavior and responding to specific commands or requests. By simulating the behavior of compromised or vulnerable IoT devices, sensor nodes can entice attackers to target them. This interaction can reveal attacker techniques, their motivations, and the types of compromise they attempt to achieve. In some embodiments, sensor nodes can act as IoT gateways or collectors, intercepting and analyzing sensor data transmitted by IoT devices. By examining the patterns and anomalies in the collected sensor data, sensor node 3200 can detect signs of compromise or malicious activities. Unusual data patterns, unexpected sensor readings, or deviations from normal behavior may indicate a compromised IoT device. In yet another embodiment, sensor node 3200 can intercept firmware updates or configuration changes initiated by attackers. By capturing and analyzing these updates, sensor node 3200 can analyze the contents of the firmware, compare it against known malicious or vulnerable firmware versions, and identify indicators of compromise. This analysis can help understand the attack vectors used, potential vulnerabilities, or malicious modifications made to the device's firmware. In other implementations, sensor node 3200 can set up traps within IoT devices, such as hidden or decoy files, misleading configurations, or tempting entry points. These traps are designed to lure attackers into specific actions or behaviors that can reveal their presence or compromise indicators. For example, placing a disguised file with enticing data on the device and monitoring any attempts to access or modify that file can help identify unauthorized access or tampering. Information gathered via IoT module 3215, and any analysis thereof, may be used by sensor node 3200 as an input when generating and/or updating a threat landscape.

According to the embodiment, alert module 3240 is present and configured to generate alerts or notifications when specific events occur. Examples of specific events can include, but are not limited to, connection alerts (e.g., triggering alerts when an attacker establishes a connection or engages with the honeypot), unusual activities (e.g., notifying security teams when certain predefined thresholds, such as the number of login attempts, are exceeded), and brute-force attempts (e.g., generating alerts when multiple unsuccessful login attempts are made from the same IP address).

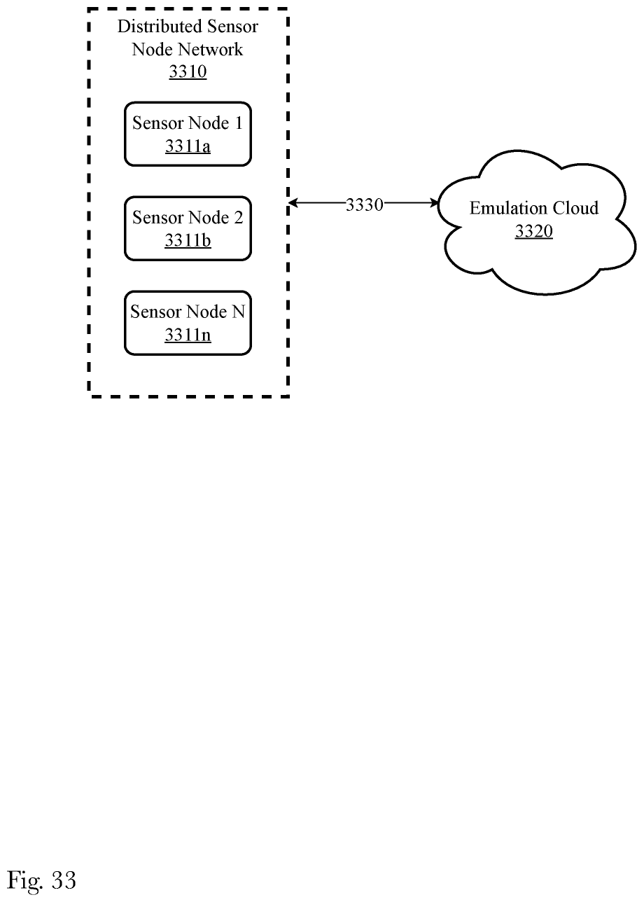

FIG. 33 is a block diagram illustrating an exemplary embodiment of a system of distributed sensor nodes configured to provide lightweight honeypot capabilities utilizing an emulation cloud configured to provide high-interactive honeypot functionality, according to an embodiment. The embodiment includes a distributed sensor node network 3310 comprising a plurality of sensor nodes 3311a-n and which communicates with an emulation cloud 3320 via a suitable communication network such as, for example, the Internet 3330. One or more of the sensor nodes 3311a-n may be configured to operate as a lightweight honeypot in accordance with one of the methods described herein, and may store and operate an emulation engine 3210 in order to provide simulated content to entice network attackers/intruders. One or more sensor nodes 3311a-n may not store and operate emulation engine 3200. Sensor nodes that do not operate an emulation engine locally may utilize an emulation cloud to respond to network traffic that may be potentially malicious or is otherwise suspicious.

Emulation cloud 3320 may be configured to function as a high-interaction honeypot, providing more complex and a broader range of services and interactions with attackers. Emulation cloud 3320 can closely simulate real system, allowing for extensive monitoring and data capture. According to the embodiment, one or more sensor nodes may analyze network traffic to identify intruder/attack traffic and then forward this identified intruder traffic to emulation cloud 3320. The traffic may be forwarded via a tunnel (e.g., Generic Routing Encapsulation (GRE), IP SEC, etc.) by encapsulating the identified traffic at the sensor node and then transported over the Internet 3330 to the cloud. In some implementations, emulation cloud 3320 may implement a cloud-based instance of an edge server configured to operate as proxy and destination endpoint of the tunnel, extracting the payload from the encapsulated packets, and then forwarding the payload to its destination. In an embodiment, edge server may be configured to analyze the received, extracted payload to determine an appropriate destination.

According to some embodiments, emulation cloud 3320 may implement a cloud-based instance of emulation engine 3210 and/or one of the modules discussed herein in order to provide containerized instances of various services, applications, and processes that may be of interest to a network intruder.

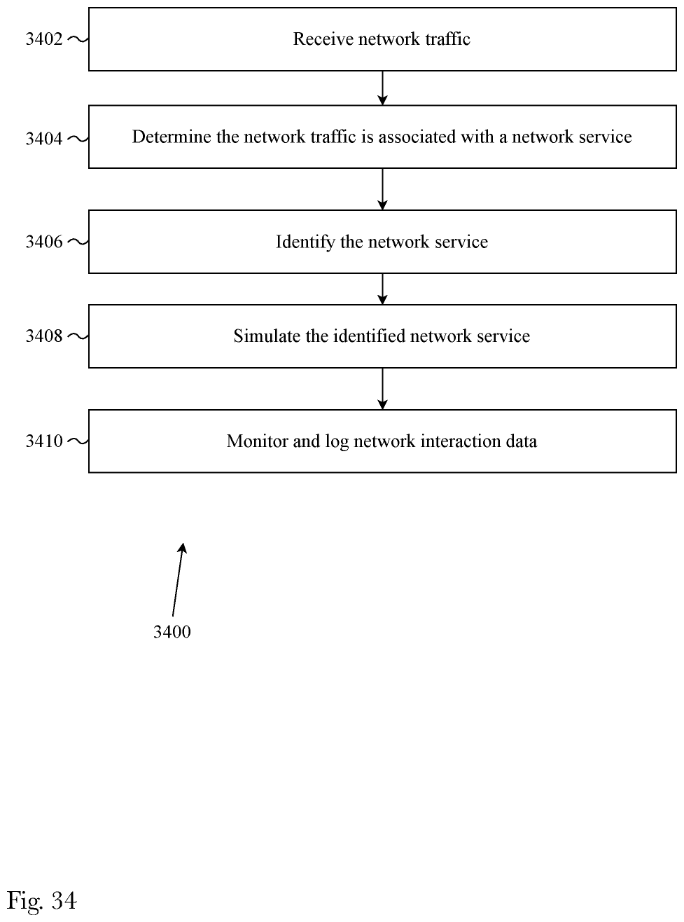

FIG. 34 is a flow diagram illustrating an exemplary method 3400 for gathering network interaction data, according to an embodiment. According to the embodiment, the process begins at step 3402 when a sensor node 3200 monitors received network traffic. The traffic may be monitored and analyzed to determine if the network traffic is associated with a network service at step 3404 and then identifying the specific network service at step 3406. In some implementations, steps 3404 and 3406 may be executed as one step. Network packets associated with traffic may be analyzed to determine the network service associated with the network traffic. At step 3408 network module 3211 can simulate the identified network service and pass the network traffic to the simulated network service. As a last step 3410 sensor node monitors and logs network interaction data as the attacker interacts with the simulated network service. In some implementations, the network interaction data may be used by sensor node 3200 to identify one or more patterns associated with an attacker or group of attackers.

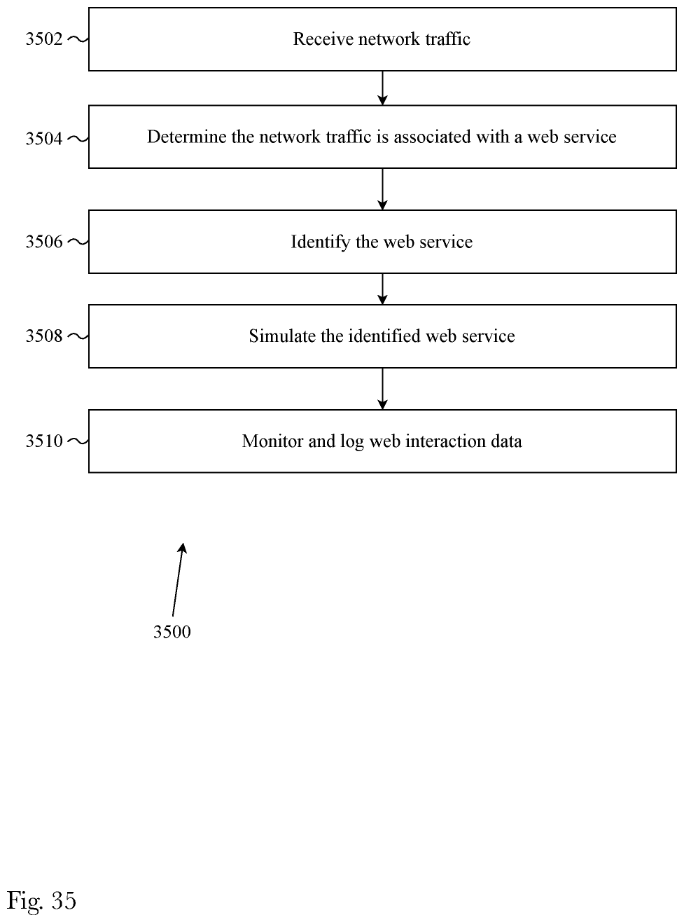

FIG. 35 is a flow diagram illustrating an exemplary method 3500 for gathering web interaction data, according to an embodiment. According to the embodiment, the process begins at step 3502 when a sensor node 3200 monitors received network traffic. The traffic may be monitored and analyzed to determine if the network traffic is associated with a web service at step 3504 and then identifying the specific web service at step 3506. In some implementations, steps 3504 and 3506 may be executed as one step. Network packets associated with traffic may be analyzed to determine the web service associated with the network traffic. At step 3508 web module 3212 can simulate the identified web service and pass the network traffic to the simulated web service. As a last step 3510 sensor node monitors and logs web interaction data as the attacker interacts with the simulated web service. In some implementations, the web interaction data may be used by sensor node 3200 to identify one or more patterns associated with an attacker or group of attackers.

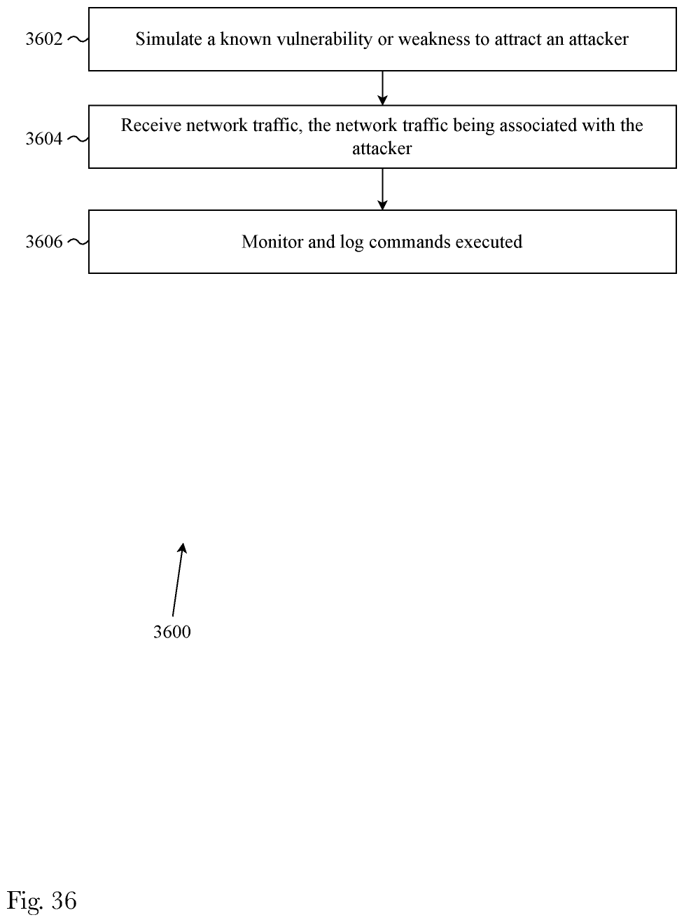

FIG. 36 is a flow diagram illustrating an exemplary method 3600 for gathering command and vulnerability exploit data, according to an embodiment. According to the embodiment, the process begins at step 3602 when vulnerability module 3213 operating on a sensor node simulates a known vulnerability or weakness to attract an attacker. At step 3604, sensor node 3200 receives network traffic, the network traffic being associated with the attacker. At step 3606 the interactions between the attacker and the sensor node are monitored and the commands executed by the attacker are logged. In some implementations, the command log data may be used by sensor node 3200 to identify one or more patterns associated with an attacker or group of attackers.

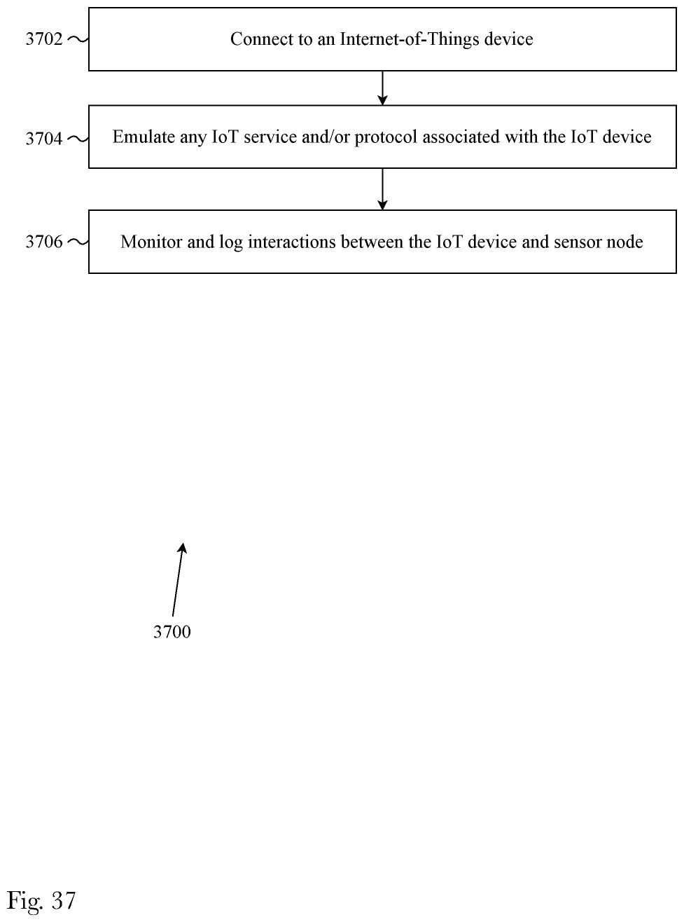

FIG. 37 is a flow diagram illustrating an exemplary method 3700 for gathering IoT reconnaissance data, according to an embodiment. According to the embodiment, the process begins at step 3702 when a sensor node 3200 connects to an IoT device. Sensor node 3200 may be configured to determine if there are IoT devices to connect to, determine a protocol or IoT service associated with the IoT device, and then connect using the appropriate protocol. The process of discovering an IoT) device can vary depending on the specific network configuration and protocols used. Here are a few common methods by which devices can discover and connect to IoT devices: network scanning, DNS service discovery, multicast DNS, wireless discovery protocols, IoT gateway or hub, and/or the like. Determining the protocol or IoT service associated with an IoT device can be done using various methods. For example, performing network analysis to inspect the traffic generated by the IoT device. Tools like Wireshark or network monitoring software can capture and analyze network packets, looking for specific protocol patterns, headers, or payload structures that can help identify the communication protocol used by the device. As another example, using port scanning tools to check the open ports on the IoT device. By identifying the open ports, sensor node 3200 can make educated guesses about the protocols or services running on those ports. Common ports associated with specific protocols, such as HTTP (port 80), MQTT (port 1883), or CoAP (port 5683), can provide clues about the protocol used. In yet another example, service fingerprinting involves analyzing the responses received from the IoT device to identify the protocol or service. It often entails sending specific requests or probes to the device and examining the responses. The characteristics of the responses can help identify the underlying protocol, such as the response headers, structure, or behavior. At step 3704 IoT module 3215 can emulate any IoT service and/or protocol associated with the IoT device. As a last step 3706 sensor node 3200 may monitor and log interactions between the IoT device and sensor node. In some implementations, the IoT interaction data may be used by sensor node 3200 to identify one or more patterns associated with an attacker or group of attackers.

According to some implementations, in execution of the various methods and processes disclosed herein, sensor node 3200 may perform deep packet inspection on monitored network traffic and applies a matching policy to identify a match between attack traffic and vulnerable services to maximize the possibility of triggering an exploit in the emulated environment.

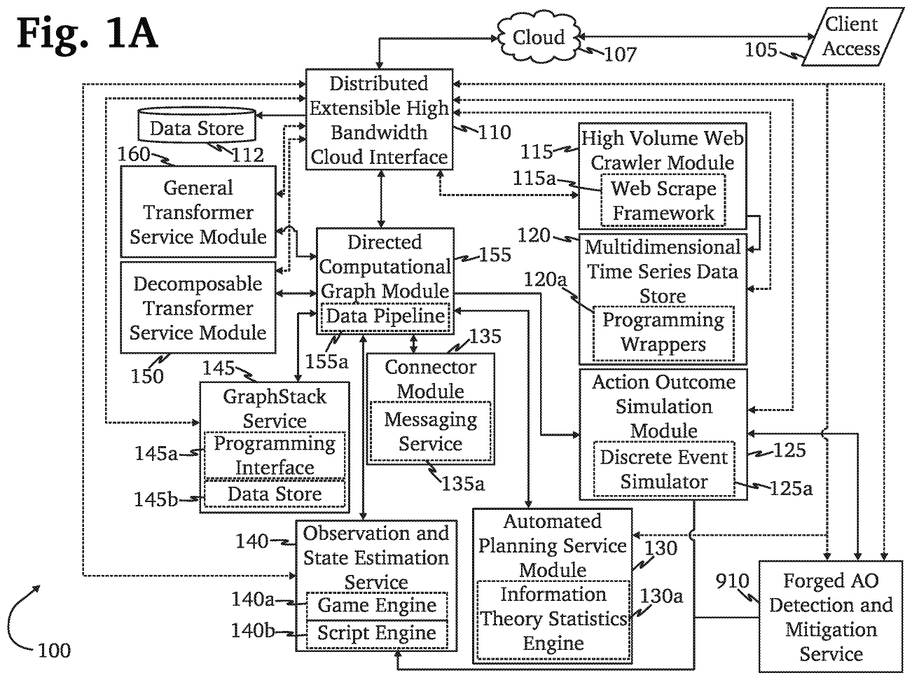

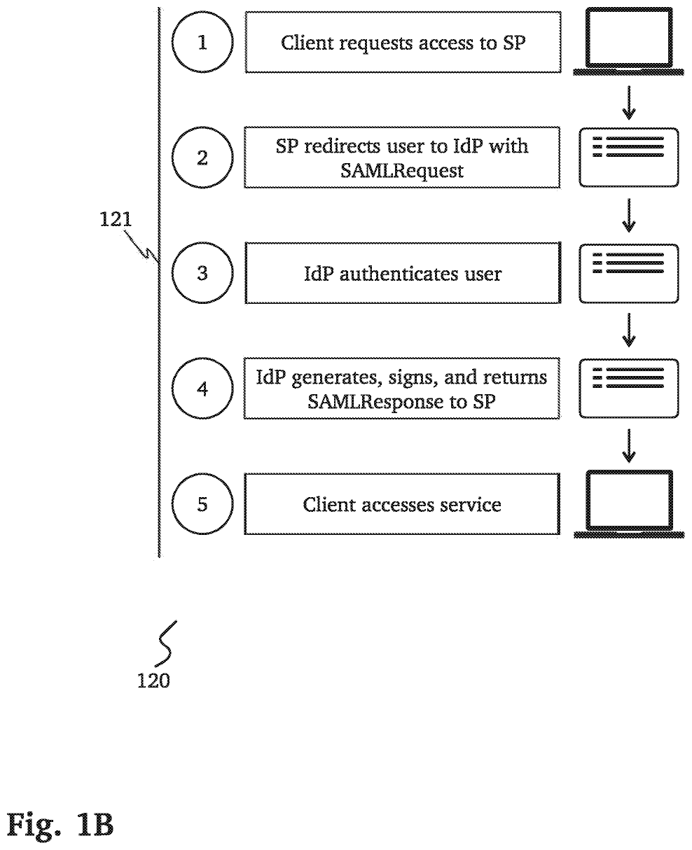

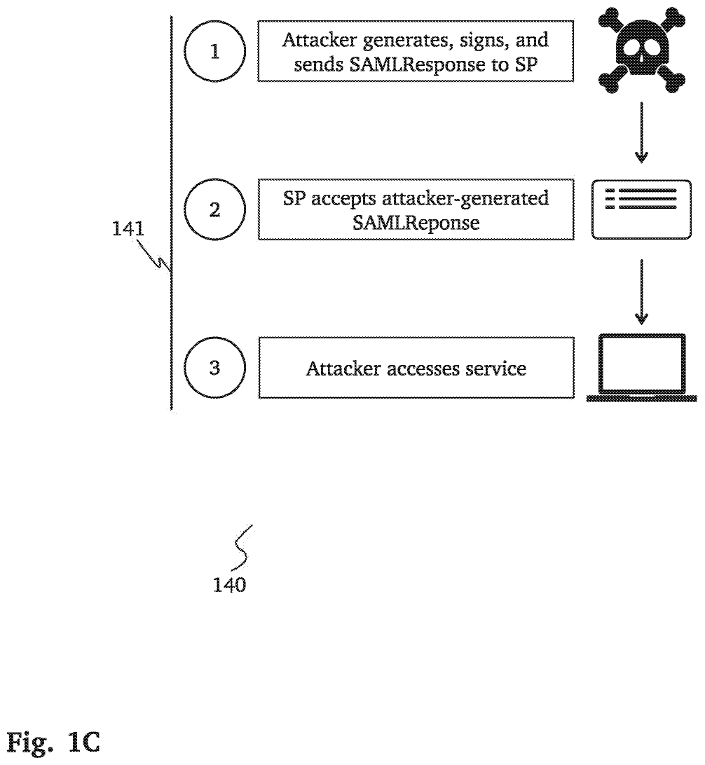

FIG. 1A is a diagram of an exemplary architecture of an advanced cyber decision platform (ACDP) 100 according to one aspect. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™, CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

For example, the Information Assurance department is notified by the system 100 that principal X is using credentials K (Kerberos Principal Key) never used by it before to access service Y. Service Y utilizes these same credentials to access secure data on data store Z. This correctly generates an alert as suspicious lateral movement through the network and will recommend isolation of X and Y and suspension of K based on continuous baseline network traffic monitoring by the multidimensional time series data store 120 programmed to process such data 120a, rigorous analysis of the network baseline by the directed computational graph 155 with its underlying general transformer service module 160 and decomposable transformer service module 150 in conjunction with the AI and primed machine learning capabilities 130a of the automated planning service module 130 which had also received and assimilated publicly available from a plurality of sources through the multi-source connection APIs of the connector module 135. Ad hoc simulations of these traffic patterns are run against the baseline by the action outcome simulation module 125 and its discrete event simulator 125a which is used here to determine probability space for likelihood of legitimacy. The system 100, based on this data and analysis, was able to detect and recommend mitigation of a cyberattack that represented an existential threat to all business operations, presenting, at the time of the attack, information most needed for an actionable plan to human analysts at multiple levels in the mitigation and remediation effort through use of the observation and state estimation service 140 which had also been specifically preprogrammed to handle cybersecurity events 140b.

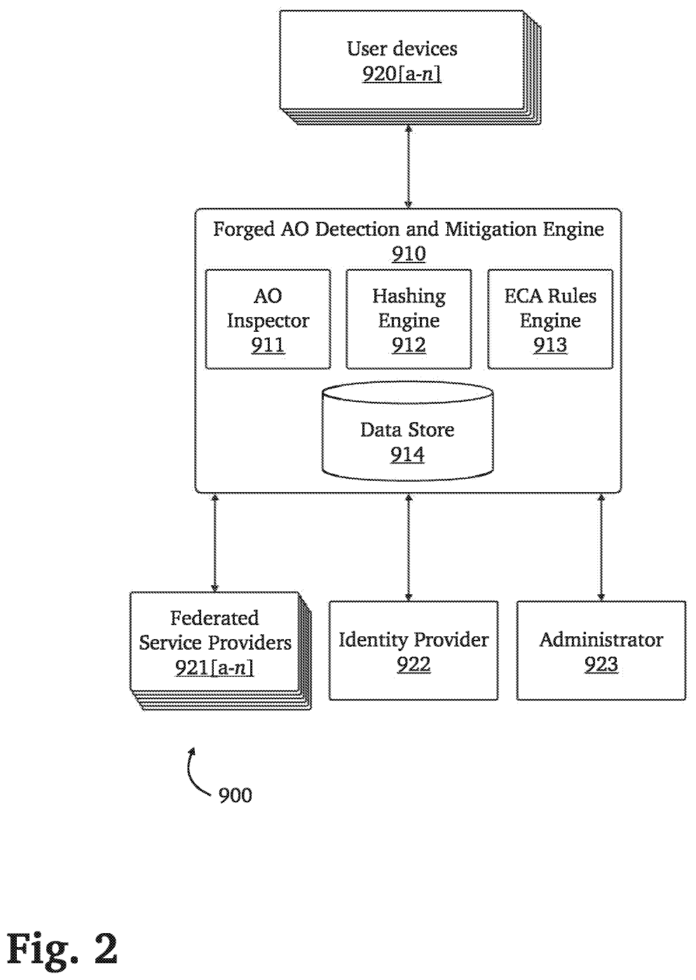

A forged authentication object detection and mitigation service 910 may be used to detect and mitigate cyberattacks stemming from the use of authentication objects generated by an attacker. Service 910 is discussed in further detail below in FIG. 2.

According to one aspect, the advanced cyber decision platform, a specifically programmed usage of the business operating system, continuously monitors a client enterprise's normal network activity for behaviors such as but not limited to normal users on the network, resources accessed by each user, access permissions of each user, machine to machine traffic on the network, sanctioned external access to the core network and administrative access to the network's identity and access management servers in conjunction with real-time analytics informing knowledge of cyberattack methodology. The system then uses this information for two purposes: First, the advanced computational analytics and simulation capabilities of the system are used to provide immediate disclosure of probable digital access points both at the network periphery and within the enterprise's information transfer and trust structure and recommendations are given on network changes that should be made to harden it prior to or during an attack. Second, the advanced cyber decision platform continuously monitors the network in real-time both for types of traffic and through techniques such as deep packet inspection for pre-decided analytically significant deviation in user traffic for indications of known cyberattack vectors such as, but not limited to, ACTIVE DIRECTORY™/Kerberos pass-the-ticket attack, ACTIVE DIRECTORY™/Kerberos pass-the-hash attack and the related ACTIVE DIRECTORY™/Kerberos overpass-the-hash attack, ACTIVE DIRECTORY™/Kerberos Skeleton Key, ACTIVE DIRECTORY™/Kerberos golden and silver ticket attack, privilege escalation attack, compromised user credentials, ransomware disk attacks, and SAML forged authentication object attack (also may be referred to as golden SAML). When suspicious activity at a level signifying an attack (for example, including but not limited to skeleton key attacks, pass-the-hash attacks, or attacks via compromised user credentials) is determined, the system issues action-focused alert information to all predesignated parties specifically tailored to their roles in attack mitigation or remediation and formatted to provide predictive attack modeling based upon historic, current, and contextual attack progression analysis such that human decision makers can rapidly formulate the most effective courses of action at their levels of responsibility in command of the most actionable information with as little distractive data as possible. The system then issues defensive measures in the most actionable form to end the attack with the least possible damage and exposure. All attack data are persistently stored for later forensic analysis.

FIG. 1B is a diagram showing a typical operation of accessing a service provider that relies on the SAML protocol for authentication 120, as used in the art. A user, using a computing device, may request access to a one of a plurality of federated servers, and through the steps listed 121, an AO is generated for the user from an identity provider (IdP). The user may then be granted access to, not only the service that was originally requested, but any trusted partners as well.

FIG. 1C is a diagram showing a method of cyberattack using a forged AO 140, which may also be referred to as a “golden SAML” attack, as known in the art. Through steps 141, an attacker, using information acquired from a compromised IdP, may generate his own AO, bypassing the need to authenticate with an IdP. Once the AO has been generated, the attacker may assume the role of any user registered with the IdP, and freely access the service providers. While using various systems and methods disclosed herein may be sufficient, additional measures for detecting and mitigating forged authentication object attacks may be required.

FIG. 2 is a block diagram illustrating an exemplary system architecture 900 for a system 910 for detecting and mitigating forged authentication object attacks according to various embodiments of the invention. Architecture 900 may comprise system 910 acting as a non-blocking intermediary between a connecting user 920, a plurality of federated service providers (SP) 921a-n, an identity provider (IdP) 922, and an administrative user 923.

System 910 may be configured to verifying incoming connections when the user has an AO, and also keeps track of legitimately generated AO's. System 910 may comprise an AO inspector 911, a hashing engine 912, an event-condition-action (ECA) rules engine 913, and a data store 914.

AO inspector 911 may be configured to use faculties of ACDP 100, for example DCG module 155 and associated transformer modules to analyze and process AO's associated with incoming connections, and observation and state estimation services 140 to monitor connections for incoming AO's. Incoming AO's may be retrieved for further analysis by system 910.

Hashing engine 912 may be configured to calculate a cryptographic hash for AOs generated by identity provider 922 using functions of ACDP 100, such as DCG module 155, generate a cryptographic hash for both incoming AO's (for analysis purposes), and new AOs created by IdP 922. A one-way hash may be used to allow protecting of sensitive information contained in the AO, but preserving uniqueness of each AO. Generated hashes may be stored in data store 914. Hashing engine may also run a hash check function, used for validating incoming AO's.

ECA rules engine 913 may be used by a network administrator to create and manage ECA rules that may trigger actions and queries in the event of detection of a forged AO. Rules may be for example, tracking and logging the actions of the suspicious user, deferring the suspicious connection, and the like. Rules may be nested to create a complex flow of various conditional checks and actions to create a set of “circuit breaker” checks to further ascertain the connection, or try and resolve the matter automatically before notifying a human network administrator.

Data store 914 may be a graph and time-series hybrid database, such as multidimensional time-series data store 120 or data store 112, that stores hashes, ECA rules, log data, and the like, and may be quickly and efficiently queried and processed using ACDP 100.

Federated service providers 921a-n may comprise a group of trusted service partners that may share a common IdP 922 in which user 920 may wish to access. Federated service providers 921a-n may be, for instance, services employing MICROSOFT'S ACTIVE DIRECTORY FEDERATED SERVICES (AS DS), AZURE AD, OKTA, many web browser single-sign-on (SSO) implementations, cloud service provides (such as, AMAZON AWS, AZURE, and GOOGLE), and the like.

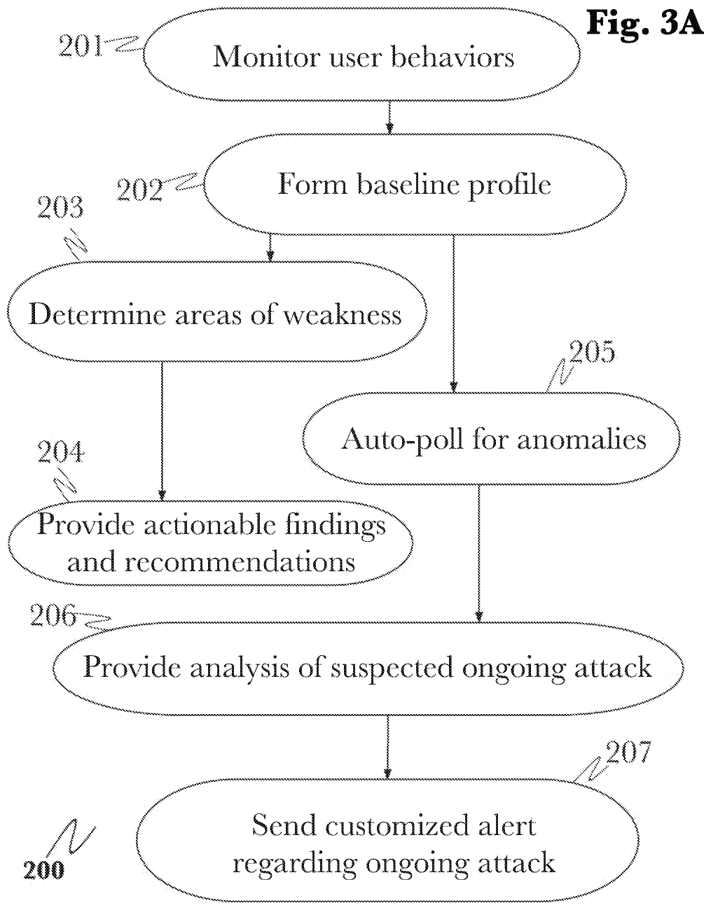

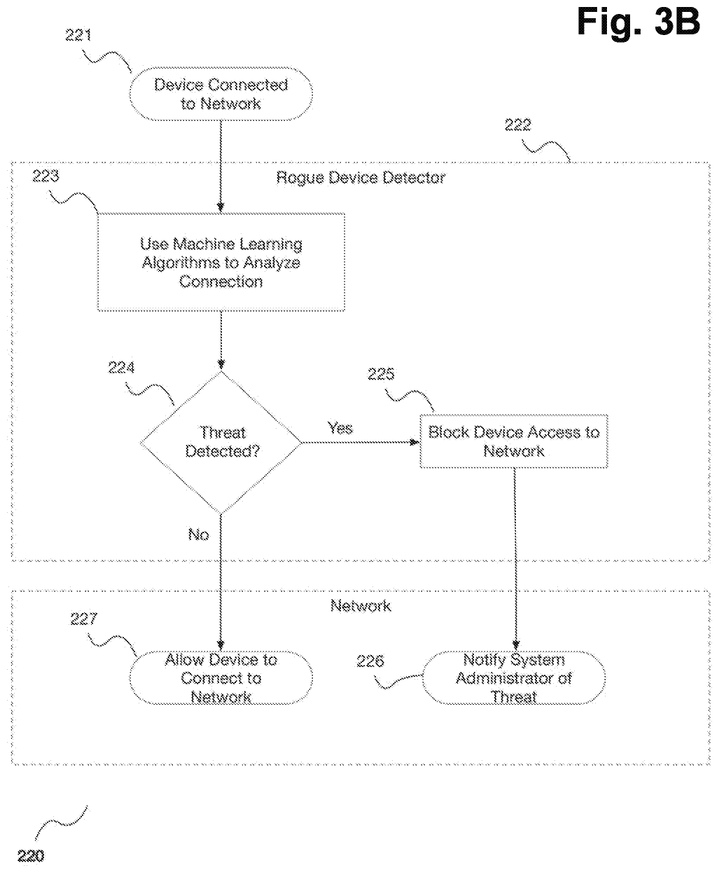

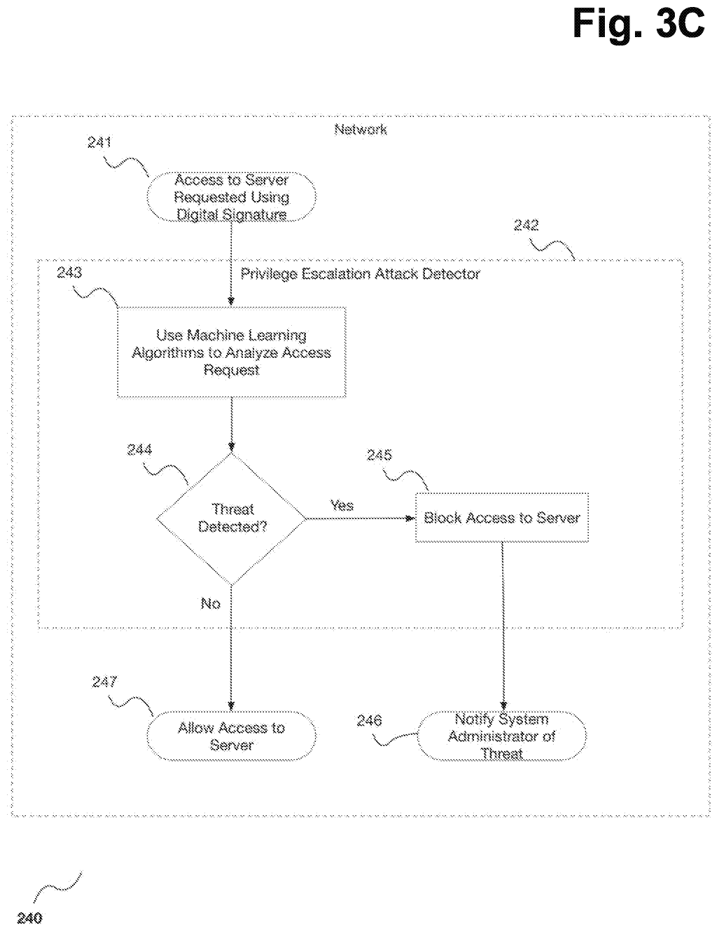

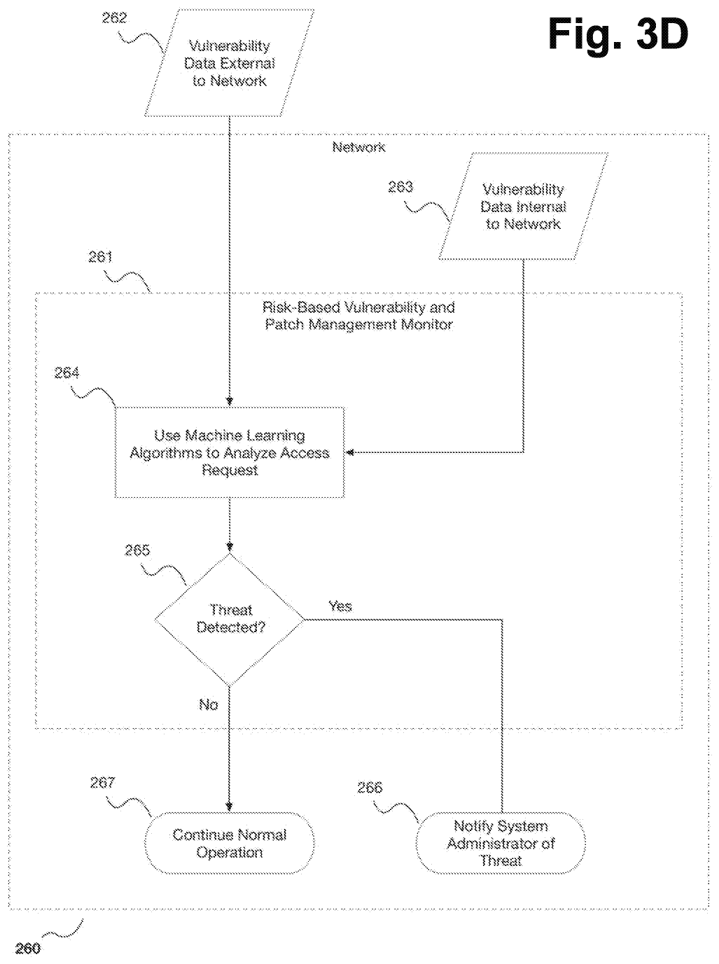

FIG. 3A is a flow diagram of an exemplary function of the business operating system in the detection and mitigation of predetermining factors leading to and steps to mitigate ongoing cyberattacks 200. The system continuously retrieves network traffic data 201 which may be stored and preprocessed by the multidimensional time series data store 120 and its programming wrappers 120a. All captured data are then analyzed to predict the normal usage patterns of network nodes such as internal users, network connected systems and equipment and sanctioned users external to the enterprise boundaries for example off-site employees, contractors and vendors, just to name a few likely participants. Of course, normal other network traffic may also be known to those skilled in the field, the list given is not meant to be exclusive and other possibilities would not fall outside the design of the invention. Analysis of network traffic may include graphical analysis of parameters such as network item to network usage using specifically developed programming in the graphstack service 145, 145a, analysis of usage by each network item may be accomplished by specifically pre-developed algorithms associated with the directed computational graph module 155, general transformer service module 160 and decomposable service module 150, depending on the complexity of the individual usage profile 201. These usage pattern analyses, in conjunction with additional data concerning an enterprise's network topology; gateway firewall programming; internal firewall configuration; directory services protocols and configuration; and permissions profiles for both users and for access to sensitive information, just to list a few non-exclusive examples may then be analyzed further within the automated planning service module 130, where machine learning techniques which include but are not limited to information theory statistics 130a may be employed and the action outcome simulation module 125, specialized for predictive simulation of outcome based on current data 125a may be applied to formulate a current, up-to-date and continuously evolving baseline network usage profile 202. This same data would be combined with up-to-date known cyberattack methodology reports, possibly retrieved from several divergent and exogenous sources through the use of the multi-application programming interface aware connector module 135 to present preventative recommendations to the enterprise decision makers for network infrastructure changes, physical and configuration-based to cost effectively reduce the probability of a cyberattack and to significantly and most cost effectively mitigate data exposure and loss in the event of attack 203, 204.

While some of these options may have been partially available as piecemeal solutions in the past, the ability to intelligently integrate the large volume of data from a plurality of sources on an ongoing basis followed by predictive simulation and analysis of outcome based upon that current data such that actionable, business practice efficient recommendations can be presented is both novel and necessary in this field.

Once a comprehensive baseline profile of network usage using all available network traffic data has been formulated, the specifically tasked business operating system continuously polls the incoming traffic data for activities anomalous to that baseline as determined by pre-designated boundaries 205. Examples of anomalous activities may include a user attempting to gain access several workstations or servers in rapid succession, or a user attempting to gain access to a domain server of server with sensitive information using random userIDs or another user's userID and password, or attempts by any user to brute force crack a privileged user's password, or replay of recently issued ACTIVE DIRECTORY™/Kerberos ticket granting tickets, or using a forged SAML AO, or the presence on any known, ongoing exploit on the network or the introduction of known malware to the network, just to name a very small sample of the cyberattack profiles known to those skilled in the field. The invention, being predictive as well as aware of known exploits is designed to analyze any anomalous network behavior, formulate probable outcomes of the behavior, and to then issue any needed alerts regardless of whether the attack follows a published exploit specification or exhibits novel characteristics deviant to normal network practice. Once a probable cyberattack is detected, the system then is designed to get needed information to responding parties 206 tailored, where possible, to each role in mitigating the attack and damage arising from it 207. This may include the exact subset of information included in alerts and updates and the format in which the information is presented which may be through the enterprise's existing security information and event management system. Network administrators, then, might receive information such as but not limited to where on the network the attack is believed to have originated, what systems are believed currently affected, predictive information on where the attack may progress, what enterprise information is at risk and actionable recommendations on repelling the intrusion and mitigating the damage, whereas a chief information security officer may receive alert including but not limited to a timeline of the cyberattack, the services and information believed compromised, what action, if any has been taken to mitigate the attack, a prediction of how the attack may unfold and the recommendations given to control and repel the attack 207, although all parties may access any network and cyberattack information for which they have granted access at any time, unless compromise is suspected. Other specifically tailored updates may be issued by the system 206, 207.

FIG. 3B is a process diagram showing a general flow of the process used to detect rogue devices and analyze them for threats 220. Whenever a device is connected to the network 221, the connection is immediately sent to the rogue device detector 222 for analysis. As disclosed below at 300, the advanced cyber decision platform uses machine learning algorithms to analyze system-wide data to detect threats. The connected device is analyzed 223 to assess its device type, settings, and capabilities, the sensitivity of the data stored on the server to which the device wishes to connect, network activity, server logs, remote queries, and a multitude of other data to determine the level of threat associated with the device. If the threat reaches a certain level 224, the device is automatically prevented from accessing the network 225, and the system administrator is notified of the potential threat, along with contextually-based, tactical recommendations for optimal response based on potential impact 226. Otherwise, the device is allowed to connect to the network 227.

FIG. 3C is a process diagram showing a general flow of the process used to detect and prevent privilege escalation attacks on a network (for example, “Golden Ticket” attacks or “golden SAML” attacks) 240. When access to a server within the network is requested using a digital signature or AO 241, the connection is immediately sent to the privilege escalation attack detector 242 for analysis. As disclosed below at 300, the advanced cyber decision platform uses machine learning algorithms to analyze system-wide data to detect threats. The access request is analyzed 243 to assess the validity of the access request using the digital signature validation, plus other system-wide information such as the sensitivity of the server being accessed, the newness of the digital signature or AO, the digital signature's or AO's prior usage, and other measures of the digital signature's or AO's validity. If the assessment determines that the access request represents a significant threat 244, even despite the Kerberos validation of the digital signature or validation of a AO, the access request is automatically denied 245, and the system administrator is notified of the potential threat, along with contextually-based, tactical recommendations for optimal response based on potential impact 246. Otherwise, the access request is granted 247.

FIG. 3D is a process diagram showing a general flow of the process used to manage vulnerabilities associated with patches to network software 260. As part of a continuously-operating risk-based vulnerability and patch management monitor 261, data is gathered from both sources external to the network 262 and internal to the network 263. As disclosed below at 300, the advanced cyber decision platform uses machine learning algorithms to analyze system-wide data to detect threats. The data is analyzed 264 to determine whether network vulnerabilities exist for which a patch has not yet been created and/or applied. If the assessment determines that such a vulnerability exists 265, whether or not all software has been patched according to manufacturer recommendations, the system administrator is notified of the potential vulnerability, along with contextually-based, tactical recommendations for optimal response based on potential impact 266. Otherwise, network activity is allowed to continue normally 267.

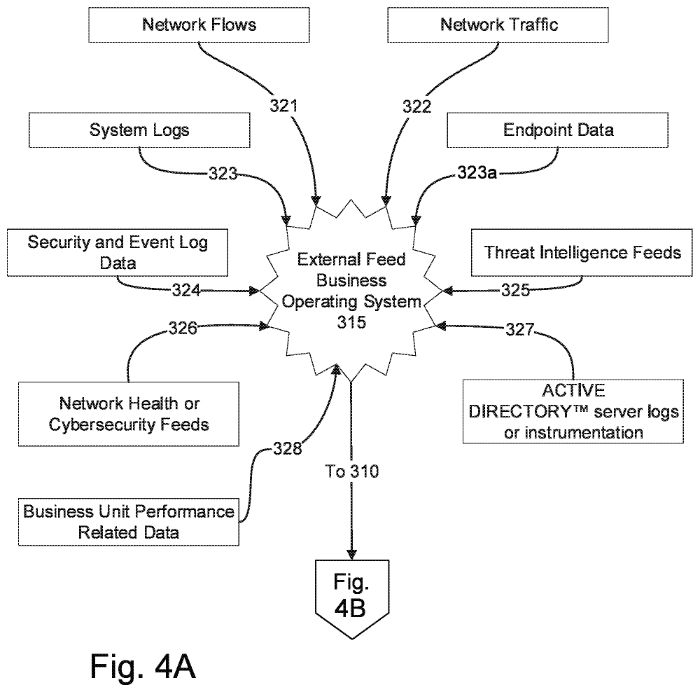

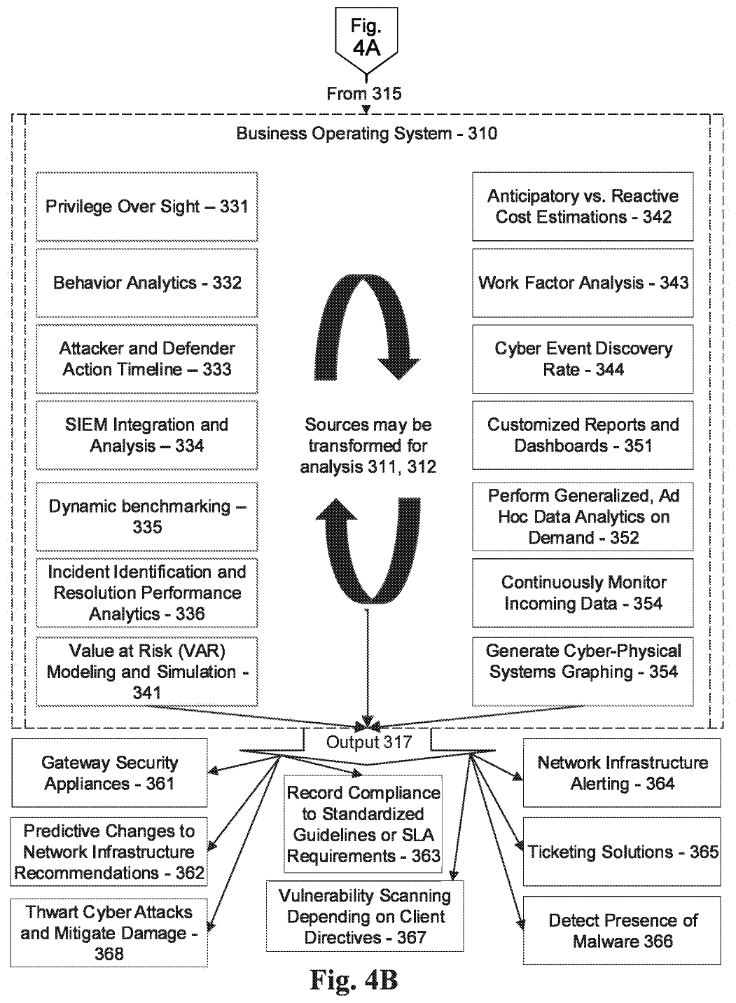

FIGS. 4A and 4B are process diagrams showing a general flow 300 of business operating system functions in use to mitigate cyberattacks. Input network data which may include network flow patterns 321, the origin and destination of each piece of measurable network traffic 322, system logs from servers and workstations on the network 323, endpoint data 323a, any security event log data from servers or available security information and event (SIEM) systems 324, external threat intelligence feeds 324a, identity or assessment context 325, external network health or cybersecurity feeds 326, Kerberos domain controller or ACTIVE DIRECTORY™ server logs or instrumentation 327 and business unit performance related data 328, among many other possible data types for which the invention was designed to analyze and integrate, may pass into 315 the business operating system 310 for analysis as part of its cyber security function. These multiple types of data from a plurality of sources may be transformed for analysis 311, 312 using at least one of the specialized cybersecurity, risk assessment or common functions of the business operating system in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the business operating system's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 368, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, and perform one time or continuous vulnerability scanning depending on client directives 367. These examples are, of course, only a subset of the possible uses of the system, they are exemplary in nature and do not reflect any boundaries in the capabilities of the invention.

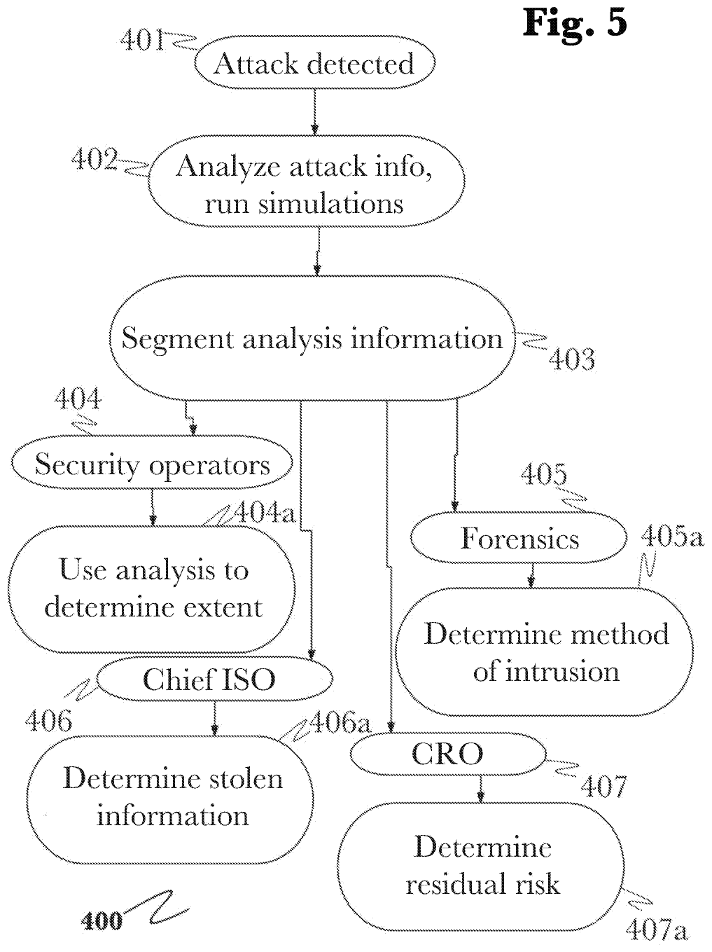

FIG. 5 is a process flow diagram of a method for segmenting cyberattack information to appropriate corporation parties 400. As previously disclosed 200, 351, one of the strengths of the advanced cyber-decision platform is the ability to finely customize reports and dashboards to specific audiences, concurrently is appropriate. This customization is possible due to the devotion of a portion of the business operating system's programming specifically to outcome presentation by modules which include the observation and state estimation service 140 with its game engine 140a and script interpreter 140b. In the setting of cybersecurity, issuance of specialized alerts, updates and reports may significantly assist in getting the correct mitigating actions done in the timeliest fashion while keeping all participants informed at predesignated, appropriate granularity. Upon the detection of a cyberattack by the system 401 all available information about the ongoing attack and existing cybersecurity knowledge are analyzed, including through predictive simulation in near real time 402 to develop both the most accurate appraisal of current events and actionable recommendations concerning where the attack may progress and how it may be mitigated. The information generated in totality is often more than any one group needs to perform their mitigation tasks. At this point, during a cyberattack, providing a single expansive and all-inclusive alert, dashboard image, or report may make identification and action upon the crucial information by each participant more difficult, therefore the cybersecurity focused arrangement may create multiple targeted information streams each concurrently designed to produce most rapid and efficacious action throughout the enterprise during the attack and issue follow-up reports with and recommendations or information that may lead to long term changes afterward 403. Examples of groups that may receive specialized information streams include but may not be limited to front line responders during the attack 404, incident forensics support both during and after the attack 405, chief information security officer 406 and chief risk officer 407 the information sent to the latter two focused to appraise overall damage and to implement both mitigating strategy and preventive changes after the attack. Front line responders may use the cyber-decision platform's analyzed, transformed and correlated information specifically sent to them 404a to probe the extent of the attack, isolate such things as: the predictive attacker's entry point onto the enterprise's network, the systems involved or the predictive ultimate targets of the attack and may use the simulation capabilities of the system to investigate alternate methods of successfully ending the attack and repelling the attackers in the most efficient manner, although many other queries known to those skilled in the art are also answerable by the invention. Simulations run may also include the predictive effects of any attack mitigating actions on normal and critical operation of the enterprise's IT systems and corporate users. Similarly, a chief information security officer may use the cyber-decision platform to predictively analyze 406a what corporate information has already been compromised, predictively simulate the ultimate information targets of the attack that may or may not have been compromised and the total impact of the attack what can be done now and in the near future to safeguard that information. Further, during retrospective forensic inspection of the attack, the forensic responder may use the cyber-decision platform 405a to clearly and completely map the extent of network infrastructure through predictive simulation and large volume data analysis. The forensic analyst may also use the platform's capabilities to perform a time series and infrastructural spatial analysis of the attack's progression with methods used to infiltrate the enterprise's subnets and servers. Again, the chief risk officer would perform analyses of what information 407a was stolen and predictive simulations on what the theft means to the enterprise as time progresses. Additionally, the system's predictive capabilities may be employed to assist in creation of a plan for changes of the IT infrastructural that should be made that are optimal for remediation of cybersecurity risk under possibly limited enterprise budgetary constraints in place at the company so as to maximize financial outcome.

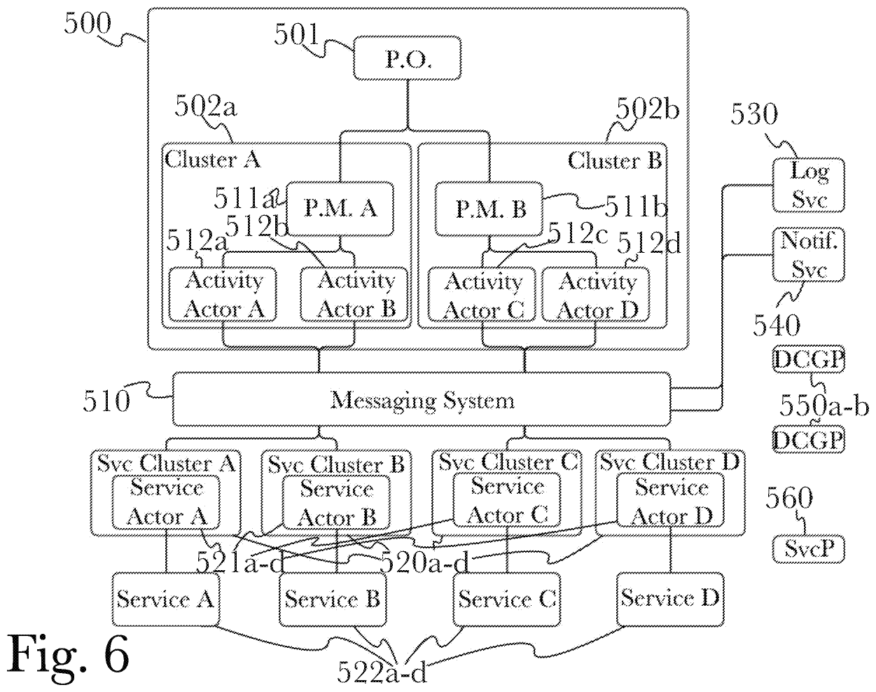

FIG. 6 is a diagram of an exemplary architecture for a system for rapid predictive analysis of very large data sets using an actor-driven distributed computational graph 500, according to one aspect. According to the aspect, a DCG 500 may comprise a pipeline orchestrator 501 that may be used to perform a variety of data transformation functions on data within a processing pipeline, and may be used with a messaging system 510 that enables communication with any number of various services and protocols, relaying messages and translating them as needed into protocol-specific API system calls for interoperability with external systems (rather than requiring a particular protocol or service to be integrated into a DCG 500).

Pipeline orchestrator 501 may spawn a plurality of child pipeline clusters 502a-b, which may be used as dedicated workers for streamlining parallel processing. In some arrangements, an entire data processing pipeline may be passed to a child cluster 502a for handling, rather than individual processing tasks, enabling each child cluster 502a-b to handle an entire data pipeline in a dedicated fashion to maintain isolated processing of different pipelines using different cluster nodes 502a-b. Pipeline orchestrator 501 may provide a software API for starting, stopping, submitting, or saving pipelines. When a pipeline is started, pipeline orchestrator 501 may send the pipeline information to an available worker node 502a-b, for example using AKKA™ clustering. For each pipeline initialized by pipeline orchestrator 501, a reporting object with status information may be maintained. Streaming activities may report the last time an event was processed, and the number of events processed. Batch activities may report status messages as they occur. Pipeline orchestrator 501 may perform batch caching using, for example, an IGFS™ caching filesystem. This allows activities 512a-d within a pipeline 502a-b to pass data contexts to one another, with any necessary parameter configurations.

A pipeline manager 511a-b may be spawned for every new running pipeline, and may be used to send activity, status, lifecycle, and event count information to the pipeline orchestrator 501. Within a particular pipeline, a plurality of activity actors 512a-d may be created by a pipeline manager 511a-b to handle individual tasks, and provide output to data services 522a-d. Data models used in a given pipeline may be determined by the specific pipeline and activities, as directed by a pipeline manager 511a-b. Each pipeline manager 511a-b controls and directs the operation of any activity actors 512a-d spawned by it. A pipeline process may need to coordinate streaming data between tasks. For this, a pipeline manager 511a-b may spawn service connectors to dynamically create TCP connections between activity instances 512a-d. Data contexts may be maintained for each individual activity 512a-d, and may be cached for provision to other activities 512a-d as needed. A data context defines how an activity accesses information, and an activity 512a-d may process data or simply forward it to a next step. Forwarding data between pipeline steps may route data through a streaming context or batch context.

A client service cluster 530 may operate a plurality of service actors 521a-d to serve the requests of activity actors 512a-d, ideally maintaining enough service actors 521a-d to support each activity per the service type. These may also be arranged within service clusters 520a-d, in a manner similar to the logical organization of activity actors 512a-d within clusters 502a-b in a data pipeline. A logging service 530 may be used to log and sample DCG requests and messages during operation while notification service 540 may be used to receive alerts and other notifications during operation (for example to alert on errors, which may then be diagnosed by reviewing records from logging service 530), and by being connected externally to messaging system 510, logging and notification services can be added, removed, or modified during operation without impacting DCG 500. A plurality of DCG protocols 550a-b may be used to provide structured messaging between a DCG 500 and messaging system 510, or to enable messaging system 510 to distribute DCG messages across service clusters 520a-d as shown. A service protocol 560 may be used to define service interactions so that a DCG 500 may be modified without impacting service implementations. In this manner it can be appreciated that the overall structure of a system using an actor-driven DCG 500 operates in a modular fashion, enabling modification and substitution of various components without impacting other operations or requiring additional reconfiguration.

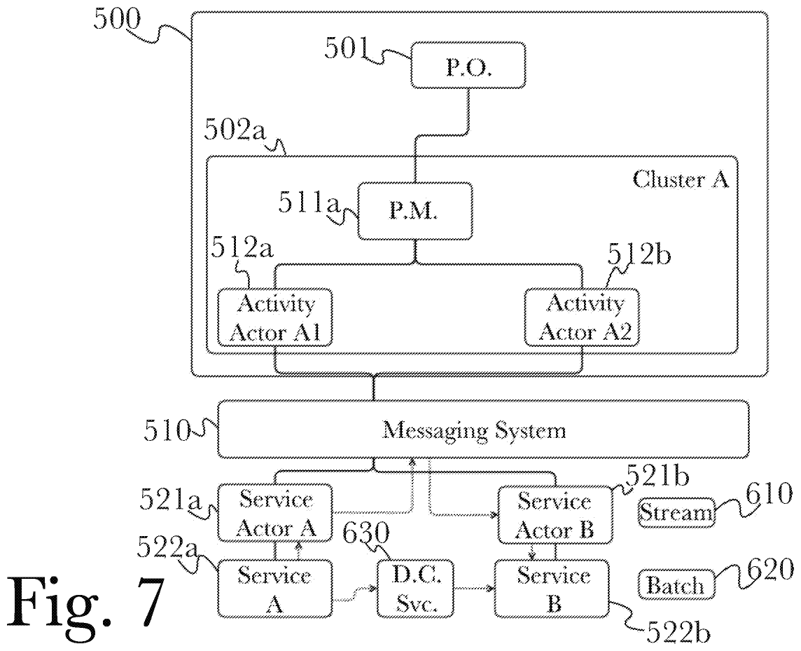

FIG. 7 is a diagram of an exemplary architecture for a system for rapid predictive analysis of very large data sets using an actor-driven distributed computational graph 500, according to one aspect. According to the aspect, a variant messaging arrangement may utilize messaging system 510 as a messaging broker using a streaming protocol 610, transmitting and receiving messages immediately using messaging system 510 as a message broker to bridge communication between service actors 521a-b as needed. Alternately, individual services 522a-b may communicate directly in a batch context 620, using a data context service 630 as a broker to batch-process and relay messages between services 522a-b.

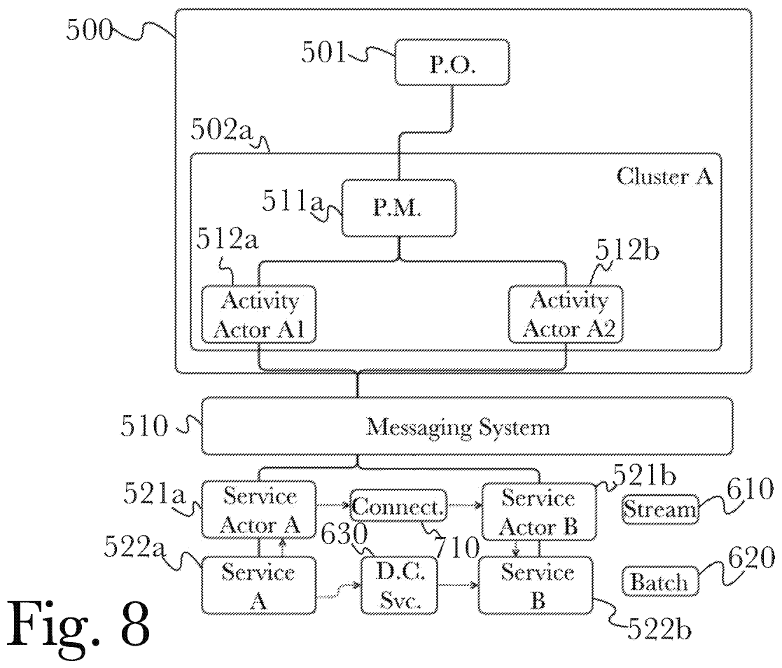

FIG. 8 is a diagram of an exemplary architecture for a system for rapid predictive analysis of very large data sets using an actor-driven distributed computational graph 500, according to one aspect. According to the aspect, a variant messaging arrangement may utilize a service connector 710 as a central message broker between a plurality of service actors 521a-b, bridging messages in a streaming context 610 while a data context service 630 continues to provide direct peer-to-peer messaging between individual services 522a-b in a batch context 620.

It should be appreciated that various combinations and arrangements of the system variants described above (referring to FIGS. 1A-8) may be possible, for example using one particular messaging arrangement for one data pipeline directed by a pipeline manager 511a-b, while another pipeline may utilize a different messaging arrangement (or may not utilize messaging at all). In this manner, a single DCG 500 and pipeline orchestrator 501 may operate individual pipelines in the manner that is most suited to their particular needs, with dynamic arrangements being made possible through design modularity as described above in FIG. 6.

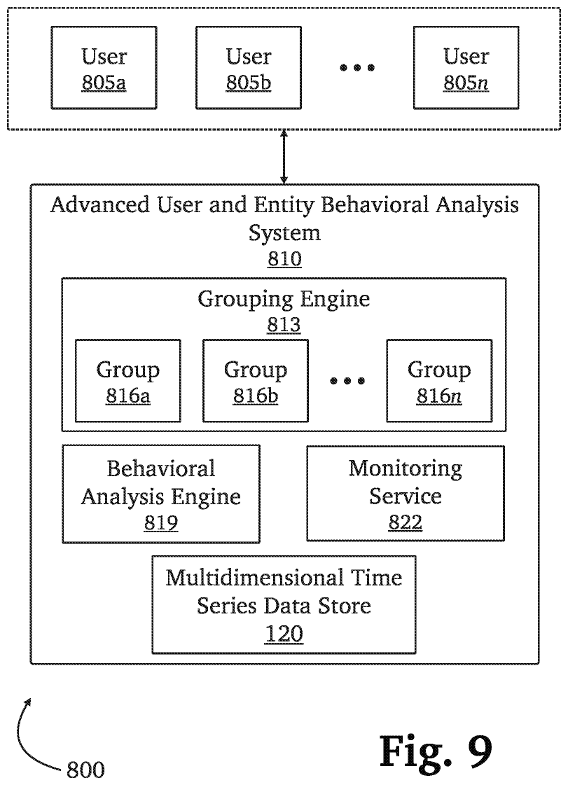

Another way to detect cyberthreats may be through the continuous monitoring and analysis of user and device behavioral patterns. This method may be particularly useful when there is little info available on an exploit, for example, a newly developed malware. FIG. 9 is a diagram of an exemplary architecture 800 for a user and entity behavioral analysis system, according to one aspect. Architecture 800 may comprise a plurality of users 805a-n, which may be individuals or connected devices, connecting to a user and entity behavioral analysis system 810. System 810 may comprise a grouping engine 813, a behavioral analysis engine 819, a monitoring service 822, and a multidimensional time series data store 120 for storing gathered and processed data. Grouping engine 813 may be configured to gather and identify user interactions and related metrics, which may include volume of interaction, frequency of interaction, and the like. Grouping engine 813 may use graph stack service 145 and DCG module 155 to convert and analyze the data in graph format. The interaction data may then be used to split users 805a-n into a plurality of groups 816a-n. Groupings may be based on department, project teams, interaction frequency, and other metrics which may be user-defined. Groupings may not be permanent, and may be adjusted and changed in real-time as group dynamics change. This may be automated by system 810, or an administrative user may manually change the groupings.

Behavioral analysis engine 819 may batch process and aggregate overall usage logs, access logs, KERBEROS session data, SAML session sata, or data collected through the use of other network monitoring tools commonly used in the art such as BRO or SURICATA. The aggregated data may then be used to generate a behavioral baseline for each group established by grouping engine 813. Behavioral analysis engine 819 may use graph stack service 145 and DCG module 155 to convert and analyze the data in graph format using various machine learning models, and may also process the data using parallel computing to quickly process large amounts of data. Models may be easily added to the system. Behavioral analysis engine 819 may also be configured to process internal communications, such as email, using natural language processing. This may provide additional insight into current group dynamics so that a more accurate baseline may be established, or may provide an insight into health and mood of users.

Monitoring service 822 may actively monitor groups for anomalous behavior, as based the established baseline. For example, monitoring service 822 may use the data pipelines of ACDP system 100 or multidimensional time series data store 120 to conduct real-time monitoring of various network resource sensors. Aspects that may be monitored may include, but is not limited to, anomalous web browsing, for example, the number of distinct domains visited exceeding a predefined threshold; anomalous data exfiltration, for example, the amount of outgoing data exceeding a predefined threshold; unusual domain access, for example, a subgroup consisting a few members within an established group demonstrating unusual browsing behavior by accessing an unusual domain a predetermined number of times within a certain timeframe; anomalous login times, for example, a user logging into a workstation during off-hours; unlikely login locations, for example, a user logging in using an account from two distinct locations that may be physically impossible within a certain timeframe; anomalous service access, for example, unusual application access or usage pattern; and new machines, for example, a user logging into a machine or server not typically accessed.

### Detailed Description of Exemplary Aspects

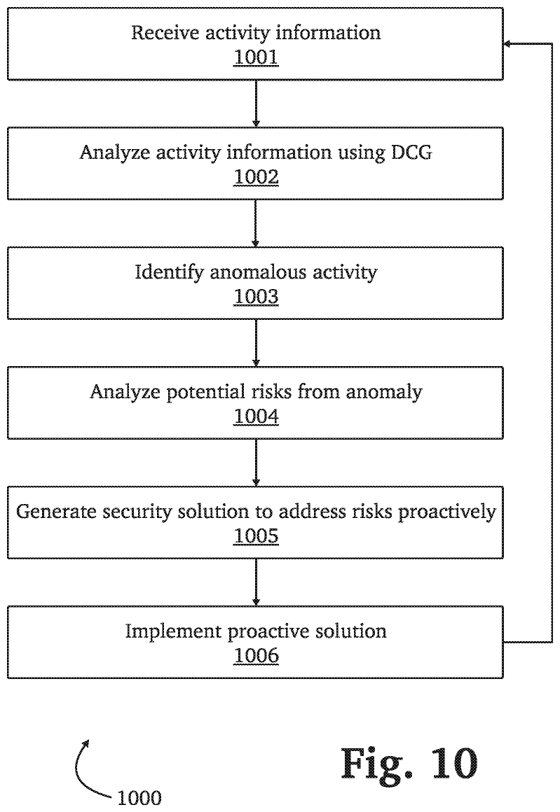

FIG. 10 is a flow diagram of an exemplary method 1000 for cybersecurity behavioral analytics, according to one aspect. According to the aspect, behavior analytics may utilize passive information feeds from a plurality of existing endpoints (for example, including but not limited to user activity on a network, network performance, or device behavior) to generate security solutions. In an initial step 1001, a web crawler 115 may passively collect activity information, which may then be processed 1002 using a DCG 155 to analyze behavior patterns. Based on this initial analysis, anomalous behavior may be recognized 1003 (for example, based on a threshold of variance from an established pattern or trend) such as high-risk users or malicious software operators such as bots. These anomalous behaviors may then be used 1004 to analyze potential angles of attack and then produce 1005 security suggestions based on this second-level analysis and predictions generated by an action outcome simulation module 125 to determine the likely effects of the change. The suggested behaviors may then be automatically implemented 1006 as needed. Passive monitoring 1001 then continues, collecting information after new security solutions are implemented 1006, enabling machine learning to improve operation over time as the relationship between security changes and observed behaviors and threats are observed and analyzed.

This method 1000 for behavioral analytics enables proactive and high-speed reactive defense capabilities against a variety of cyberattack threats, including anomalous human behaviors as well as nonhuman “bad actors” such as automated software bots that may probe for, and then exploit, existing vulnerabilities. Using automated behavioral learning in this manner provides a much more responsive solution than manual intervention, enabling rapid response to threats to mitigate any potential impact. Utilizing machine learning behavior further enhances this approach, providing additional proactive behavior that is not possible in simple automated approaches that merely react to threats as they occur.

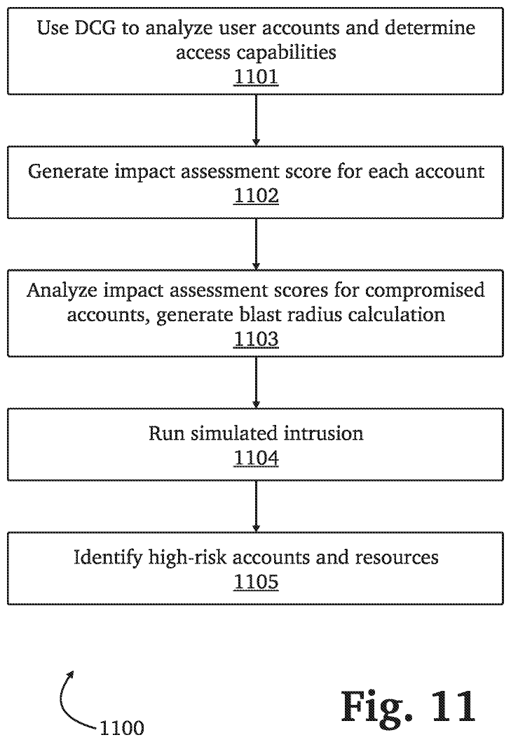

FIG. 11 is a flow diagram of an exemplary method 1100 for measuring the effects of cybersecurity attacks, according to one aspect. According to the aspect, impact assessment of an attack may be measured using a DCG 155 to analyze a user account and identify its access capabilities 1101 (for example, what files, directories, devices or domains an account may have access to). This may then be used to generate 1102 an impact assessment score for the account, representing the potential risk should that account be compromised. In the event of an incident, the impact assessment score for any compromised accounts may be used to produce a “blast radius” calculation 1103, identifying exactly what resources are at risk as a result of the intrusion and where security personnel should focus their attention. To provide proactive security recommendations through a simulation module 125, simulated intrusions may be run 1104 to identify potential blast radius calculations for a variety of attacks and to determine 1105 high risk accounts or resources so that security may be improved in those key areas rather than focusing on reactive solutions.

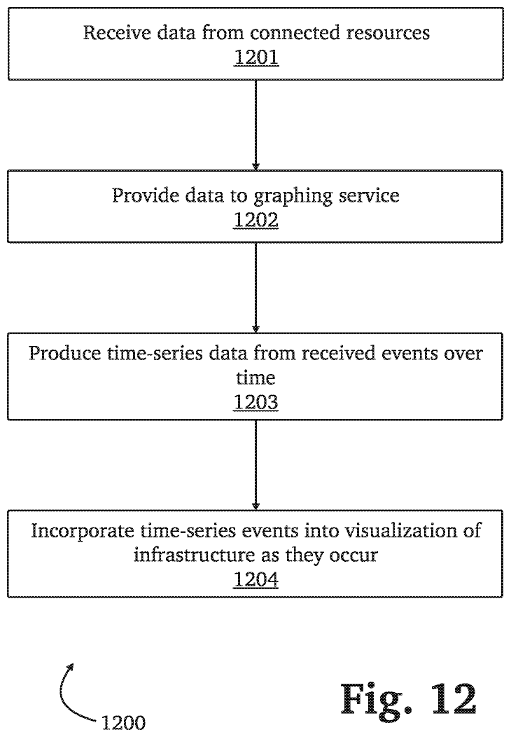

FIG. 12 is a flow diagram of an exemplary method 1200 for continuous cybersecurity monitoring and exploration, according to one aspect. According to the aspect, a state observation service 140 may receive data from a variety of connected systems 1201 such as (for example, including but not limited to) servers, domains, databases, or user directories. This information may be received continuously, passively collecting events and monitoring activity over time while feeding 1202 collected information into a graphing service 145 for use in producing time-series graphs 1203 of states and changes over time. This collated time-series data may then be used to produce a visualization 1204 of changes over time, quantifying collected data into a meaningful and understandable format. As new events are recorded, such as changing user roles or permissions, modifying servers or data structures, or other changes within a security infrastructure, these events are automatically incorporated into the time-series data and visualizations are updated accordingly, providing live monitoring of a wealth of information in a way that highlights meaningful data without losing detail due to the quantity of data points under examination.

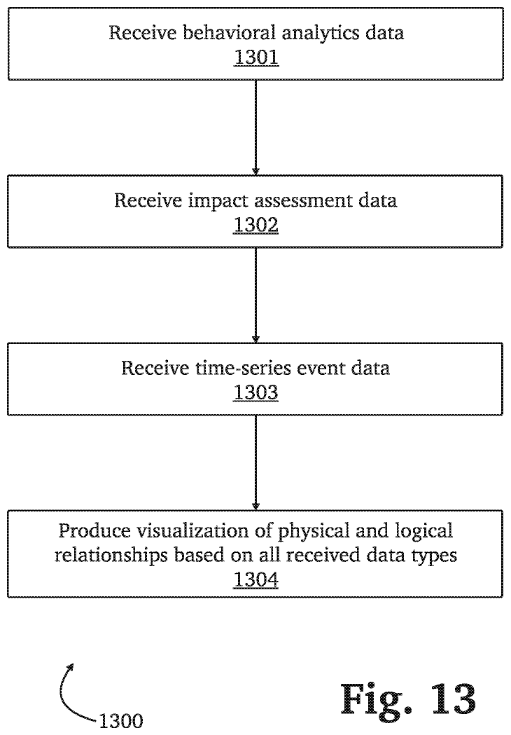

FIG. 13 is a flow diagram of an exemplary method 1300 for mapping a cyber-physical system graph (CPG), according to one aspect. According to the aspect, a cyber-physical system graph may comprise a visualization of hierarchies and relationships between devices and resources in a security infrastructure, contextualizing security information with physical device relationships that are easily understandable for security personnel and users. In an initial step 1301, behavior analytics information (as described previously, referring to FIG. 10) may be received at a graphing service 145 for inclusion in a CPG. In a next step 1302, impact assessment scores (as described previously, referring to FIG. 11) may be received and incorporated in the CPG information, adding risk assessment context to the behavior information. In a next step 1303, time-series information (as described previously, referring to FIG. 12) may be received and incorporated, updating CPG information as changes occur and events are logged. This information may then be used to produce 1304 a graph visualization of users, servers, devices, and other resources correlating physical relationships (such as a user's personal computer or smartphone, or physical connections between servers) with logical relationships (such as access privileges or database connections), to produce a meaningful and contextualized visualization of a security infrastructure that reflects the current state of the internal relationships present in the infrastructure.

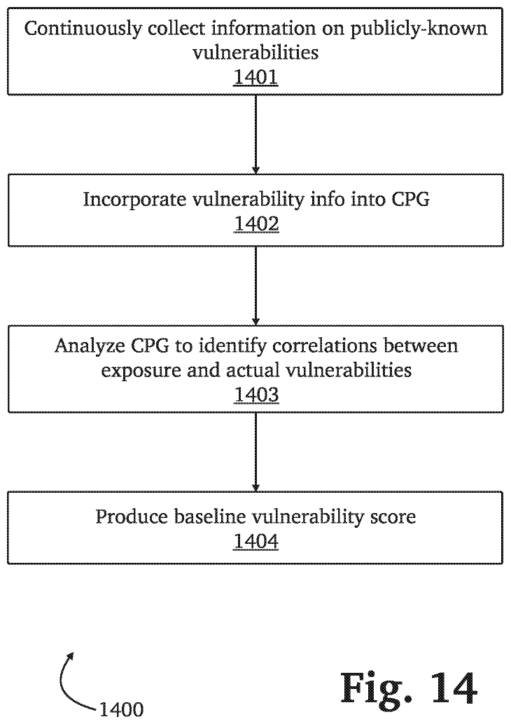

FIG. 14 is a flow diagram of an exemplary method 1400 for continuous network resilience scoring, according to one aspect. According to the aspect, a baseline score can be used to measure an overall level of risk for a network infrastructure, and may be compiled by first collecting 1401 information on publicly-disclosed vulnerabilities, such as (for example) using the Internet or common vulnerabilities and exploits (CVE) process. This information may then 1402 be incorporated into a CPG as described previously in FIG. 13, and the combined data of the CPG and the known vulnerabilities may then be analyzed 1403 to identify the relationships between known vulnerabilities and risks exposed by components of the infrastructure. This produces a combined CPG 1404 that incorporates both the internal risk level of network resources, user accounts, and devices as well as the actual risk level based on the analysis of known vulnerabilities and security risks.

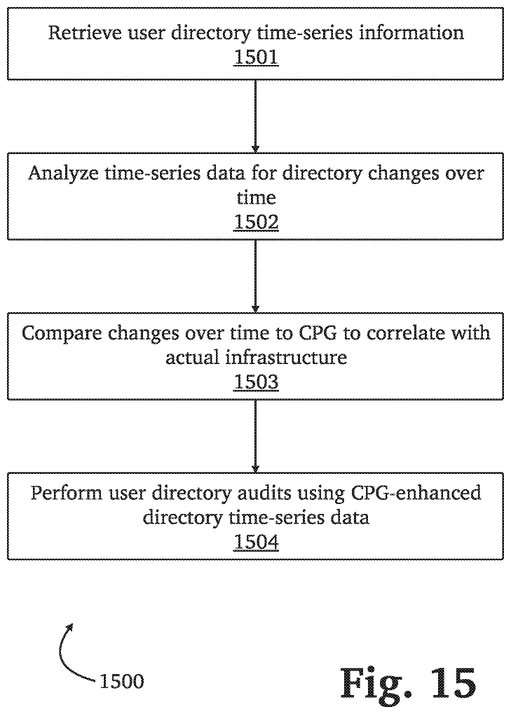

FIG. 15 is a flow diagram of an exemplary method 1500 for cybersecurity privilege oversight, according to one aspect. According to the aspect, time-series data (as described above, referring to FIG. 12) may be collected 1501 for user accounts, credentials, directories, and other user-based privilege and access information. This data may then 1502 be analyzed to identify changes over time that may affect security, such as modifying user access privileges or adding new users. The results of analysis may be checked 1503 against a CPG (as described previously in FIG. 13), to compare and correlate user directory changes with the actual infrastructure state. This comparison may be used to perform accurate and context-enhanced user directory audits 1504 that identify not only current user credentials and other user-specific information, but changes to this information over time and how the user information relates to the actual infrastructure (for example, credentials that grant access to devices and may therefore implicitly grant additional access due to device relationships that were not immediately apparent from the user directory alone).

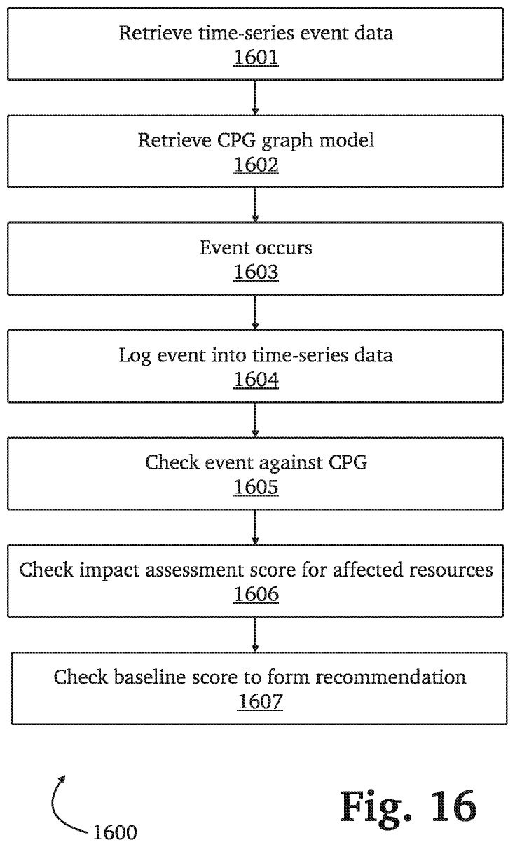

FIG. 16 is a flow diagram of an exemplary method 1600 for cybersecurity risk management, according to one aspect. According to the aspect, multiple methods described previously may be combined to provide live assessment of attacks as they occur, by first receiving 1601 time-series data for an infrastructure (as described previously, in FIG. 12) to provide live monitoring of network events. This data is then enhanced 1602 with a CPG (as described above in FIG. 13) to correlate events with actual infrastructure elements, such as servers or accounts. When an event (for example, an attempted attack against a vulnerable system or resource) occurs 1603, the event is logged in the time-series data 1604, and compared against the CPG 1605 to determine the impact. This is enhanced with the inclusion of impact assessment information 1606 for any affected resources, and the attack is then checked against a baseline score 1607 to determine the full extent of the impact of the attack and any necessary modifications to the infrastructure or policies.

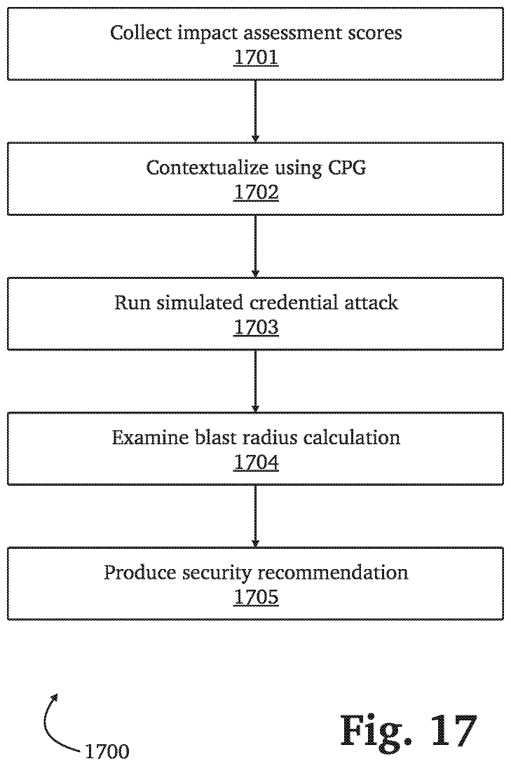

FIG. 17 is a flow diagram of an exemplary method 1700 for mitigating compromised credential threats, according to one aspect. According to the aspect, impact assessment scores (as described previously, referring to FIG. 11) may be collected 1701 for user accounts in a directory, so that the potential impact of any given credential attack is known in advance of an actual attack event. This information may be combined with a CPG 1702 as described previously in FIG. 13, to contextualize impact assessment scores within the infrastructure (for example, so that it may be predicted what systems or resources might be at risk for any given credential attack). A simulated attack may then be performed 1703 to use machine learning to improve security without waiting for actual attacks to trigger a reactive response. A blast radius assessment (as described above in FIG. 11) may be used in response 1704 to determine the effects of the simulated attack and identify points of weakness, and produce a recommendation report 1705 for improving and hardening the infrastructure against future attacks.

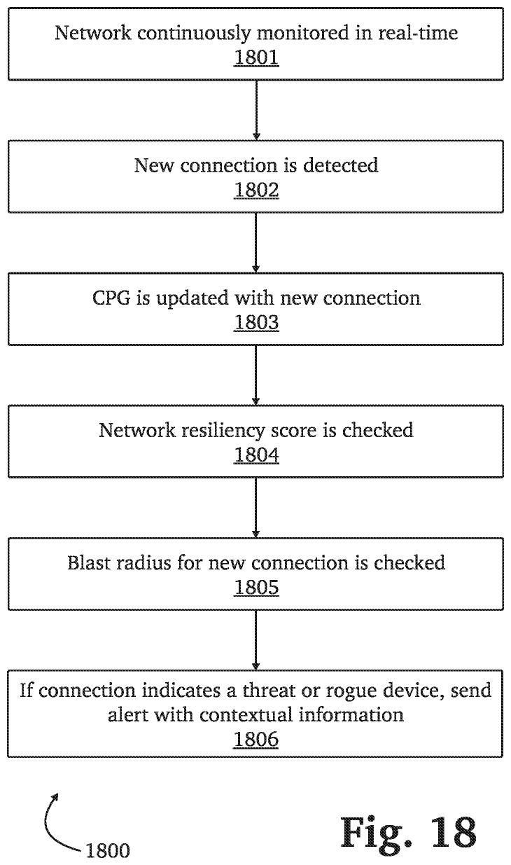

FIG. 18 is a flow diagram of an exemplary method 1800 for dynamic network and rogue device discovery, according to one aspect. According to the aspect, an advanced cyber decision platform may continuously monitor a network in real-time 1801, detecting any changes as they occur (for example, using network discovery to identify any new connections or devices as they appear on the network). When a new connection is detected 1802, a CPG may be updated 1803 with the new connection information, which may then be used as a fingerprint and compared against the network's resiliency score 1804 to examine for potential risk. The blast radius metric for any other devices involved in the connection may also be checked 1805, to examine the context of the connection for risk potential (for example, an unknown connection to an internal data server with sensitive information may be considered a much higher risk than an unknown connection to an externally-facing web server). If the connection is a risk, an alert may be sent to an administrator 1806 with the contextual information for the connection to provide a concise notification of relevant details for quick handling.

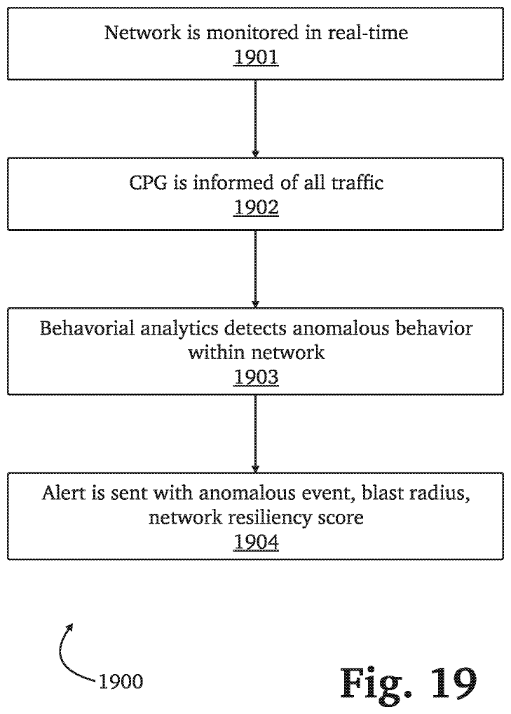

FIG. 19 is a flow diagram of an exemplary method 1900 for Kerberos “golden ticket” attack and “golden SAML” attack detection, according to one aspect. To detect these forms of attack, behavioral analytics may be employed to detect erroneously-issued authentication tickets or forged AOs, whether from incorrect configuration or from an attack. According to the aspect, an advanced cyber decision platform may continuously monitor a network 1901, informing a CPG in real-time of all traffic associated with people, places, devices, or services 1902. Machine learning algorithms detect behavioral anomalies as they occur in real-time 1903, notifying administrators with an assessment of the anomalous event 1904 as well as a blast radius score for the particular event and a network resiliency score to advise of the overall health of the network. By automatically detecting unusual behavior and informing an administrator of the anomaly along with contextual information for the event and network, a compromised ticket is immediately detected when a new authentication connection is made.

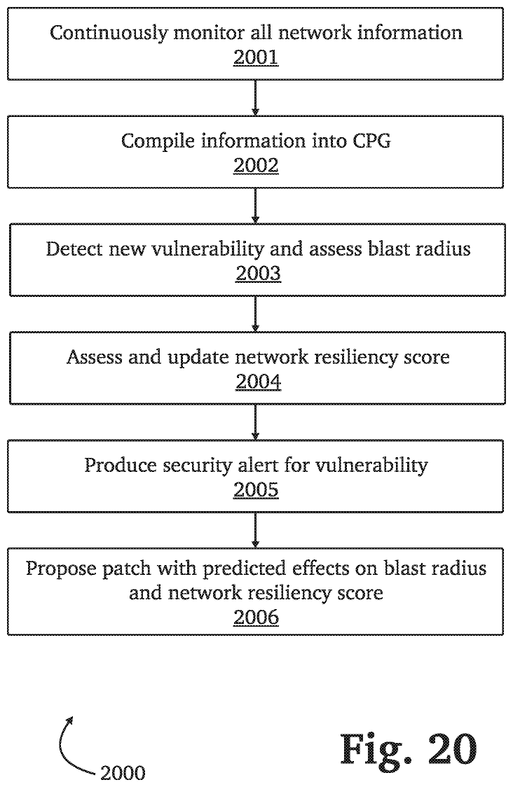

FIG. 20 is a flow diagram of an exemplary method 2000 for risk-based vulnerability and patch management, according to one aspect. According to the aspect, an advanced cyber decision platform may monitor all information about a network 2001, including (but not limited to) device telemetry data, log files, connections and network events, deployed software versions, or contextual user activity information. This information is incorporated into a CPG 2002 to maintain an up-to-date model of the network in real-time. When a new vulnerability is discovered, a blast radius score may be assessed 2003 and the network's resiliency score may be updated 2004 as needed. A security alert may then be produced 2005 to notify an administrator of the vulnerability and its impact, and a proposed patch may be presented 2006 along with the predicted effects of the patch on the vulnerability's blast radius and the overall network resiliency score. This determines both the total impact risk of any particular vulnerability, as well as the overall effect of each vulnerability on the network as a whole. This continuous network assessment may be used to collect information about new vulnerabilities and exploits to provide proactive solutions with clear result predictions, before attacks occur.

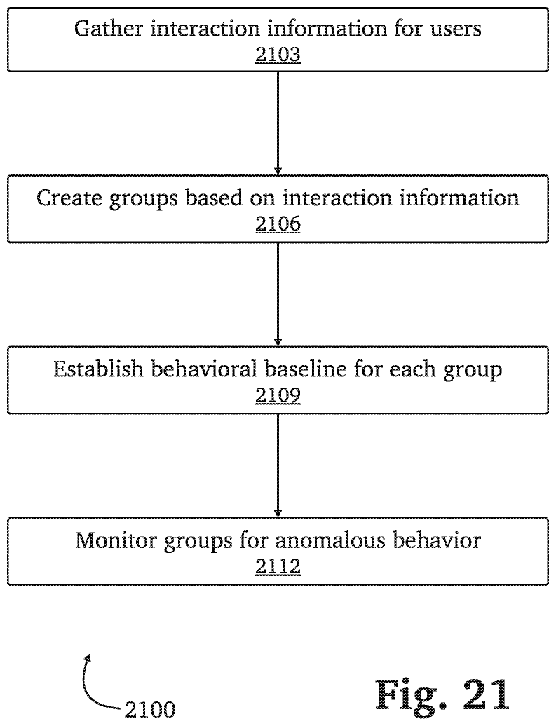

FIG. 21 is a flow diagram of an exemplary method 2100 for establishing groups of users according to one aspect. At an initial step 2103, data pertaining to network interaction between users and devices are gathered by a grouping engine. At step 2106, the grouping engine may then process the gathered information by converting it to a graph format and using DCG module to establish groupings for users. A system administrator may provide additional input, and fine-tune the groupings if required. These groupings may be applied to a domain directory, for example through automated modifications to an LDAP directory or PAM authentication module, or through integrations with external applications or services that may be used to manage users and groups within an organization. At step 2109, a behavioral baseline is established for each group that may be based on the interaction information, network logs, connected devices, and the like. At step 2112, groups are continuous monitored for anomalous behavior.

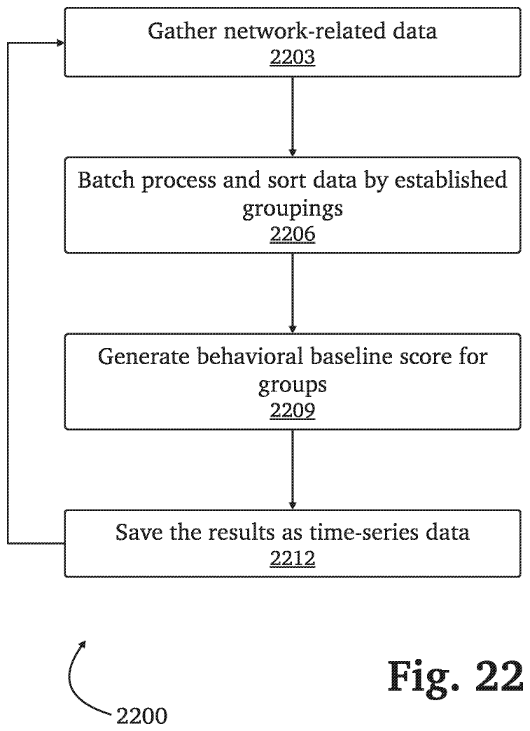

FIG. 22 is a flow diagram of an exemplary method 2200 for monitoring groups for anomalous behavior, according to one aspect. At an initial step 2203, a system, as described above in FIG. 8, gathers network-related data. This data may comprise usage logs, Kerberos sessions data, SAML sessions data, computers and other devices connected to the network, active users, software installed, and the like. At step 2206, a behavioral analysis engine may process the data. Parallel computing may be used to speed up the processing of the data. The data may then be sorted by, and associated to, previously established groupings. At step 2209, a behavioral baseline score is generated for each group based on the results of the data processing. At step 2212, the data is stored into a time-series graph database. The process repeats periodically to create snapshots of various moments in time, and stored into the database. This may allow the system to retrain the baseline to take into considering non-anomalous baseline variances that may occur over time, as well as forecast changes in group dynamics using predictive analysis functions of ACDP system 100.

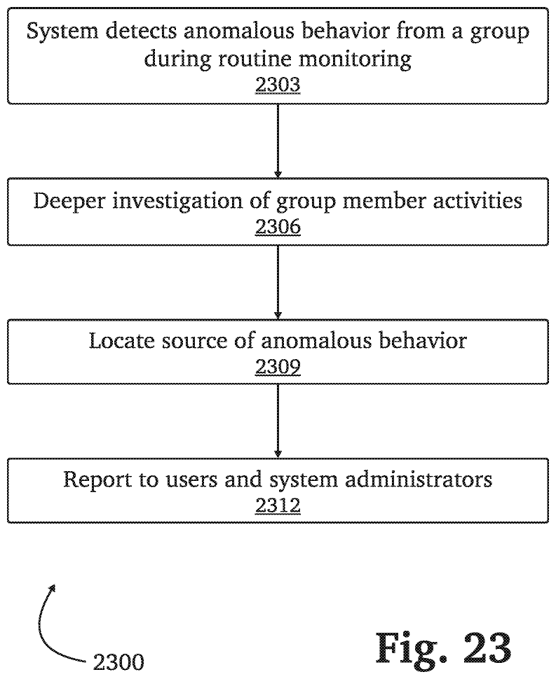

FIG. 23 is a flow diagram for an exemplary method 2300 for handing a detection of anomalous behavior, according to one aspect. At an initial step 2303, the system detects anomalous user behavior from a group. This may be based on comparison to established baselines, or a high priority incident caught during routine monitoring, for example a device accessing a blacklisted domain. At step 2306, the system investigates the group in which the anomalous behavior originated. This may include a more thorough analysis of usage and access logs. If applicable, users or devices with higher access privileges may be investigated before those with lower access privileges. At step 2309, the source or sources of the anomalous behavior is identified, and some corrective measures may be taken. For example, the offending device or user account may be automatically locked out of the network until a solution has been implemented. At step 2312, group members and system administrators may be notified. The system may utilize the various techniques discussed above to recommend a corrective action, or the system may take action automatically.

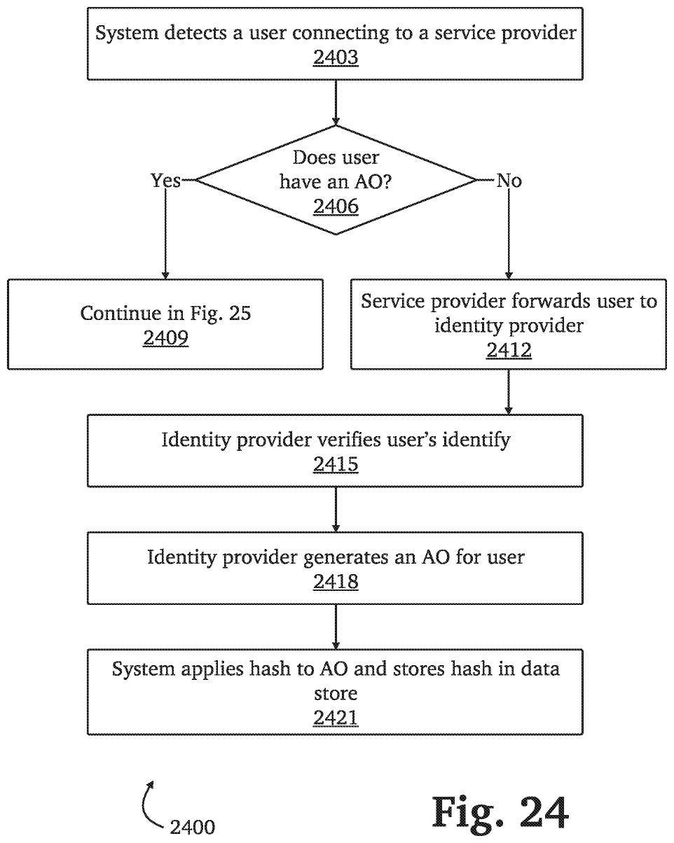

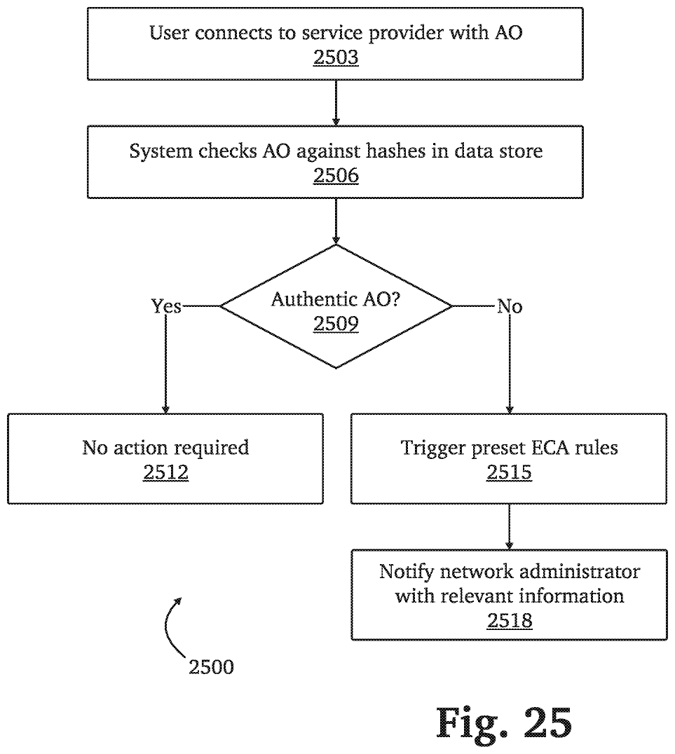

FIG. 24 is a flow diagram illustrating an exemplary method 2400 for processing a new user connection, according to one aspect. At an initial step 2403, system 910 detects a user connecting to a monitored service provider. At step 2406, if the user is connecting with an existing AO, the process leads to the method discussed in FIG. 25 at step 2409.

If the user doesn't have an existing AO, the service provider forwards the user to an identity provider at step 2412. At step 2415, the identity provider prompts the user for identifying information, such as a username and password. At step 2418, after successful verification, the IdP generates a unique AO for the user. At step 2421, system 910 retrieves the AO and uses a hashing engine to calculate a cryptographic hash for the newly generated AO, and stores the hash in a data store.

FIG. 25 is a flow diagram illustrating an exemplary method 2500 for verifying the authenticity of an authentication object, according to one aspect. At an initial step 2503, a user with an AO connects to a monitored service provider. At step 2506, system 910 detects the connection request, retrieves the AO, and generates a cryptographic hash for the AO. System 910 may now compare the newly generated hashes with previous generated hashes stored in memory. At step 2509, if the AO is found to be authentic, the connect proceeds as normal and method 2500 ends at step 2512 as no further action for this session is required. If the AO is determined to be forged, method 2500 goes to step 2515 where ECA rules may be triggered to perform their preset functions, and perform “circuit breaker” checks within a user-configurable time period. At step 2518, a network administrator at step may be notified, and sent any relevant information, such as blast radius, access logs for the forged AO connection, and the like.

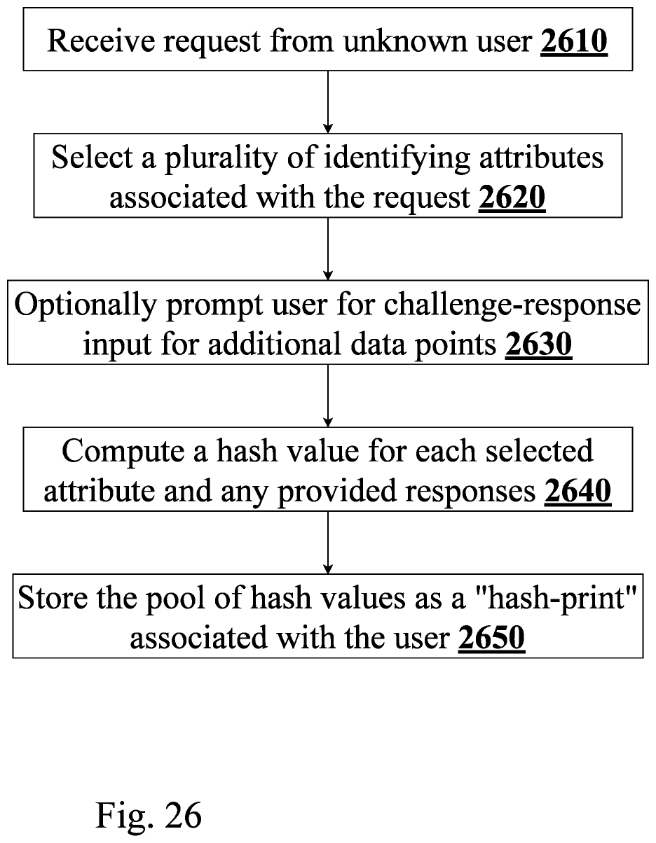

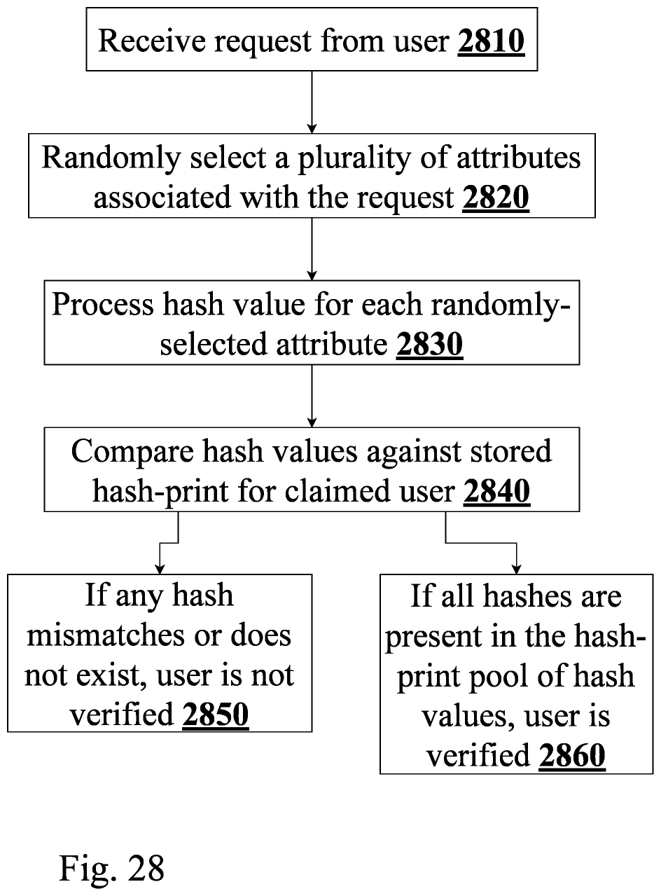

FIG. 26 is a flow diagram illustrating an exemplary method for generating an authentication hash-print for a new user, according to one aspect. According to this method, when a new user requires verification (as described previously, with reference to FIG. 24), a selection of attributes may be hashed and stored as a pool of hash values that may be referred to as a “hash-print”. This hash-print may be used in a manner similar to traditional user or session fingerprinting, verifying that a request comes from the claimed user (or account, for example a shared account that may be used by multiple human users such as in an enterprise arrangement) by verifying that the hashed values exist within the stored hash-print. When a request is received from an unknown user 2610, such as a new user or a user that has not yet verified their identity (for example, if an existing user changes to a new device), there will be no AO attached to the request upon inspection by the system's AO inspector 911. A selection of observable attributes may then be selected 2620, such as (for example, including but not limited to) a device hardware identifier, screen size, operating system type or version, browser type or version, or any other identifying details that may be associated with the request. The user may also optionally be prompted to provide a plurality of responses 2630, for example a challenge-response prompt such as asking a number of security questions, as is commonly used in user verification. A hash value may then be computed by hashing engine 912 for each attribute selected and response received (if any) 2640, and these hash values may be stored in a database 914 for future reference as a “hash-print” 2650 that is associated with the user for verifying future requests. This enables future user verification requests to compare any subset of the selected attributes against the hash-print, without requiring every attribute to be present, for example using a randomly-selected plurality of attributes as described below in FIG. 28.

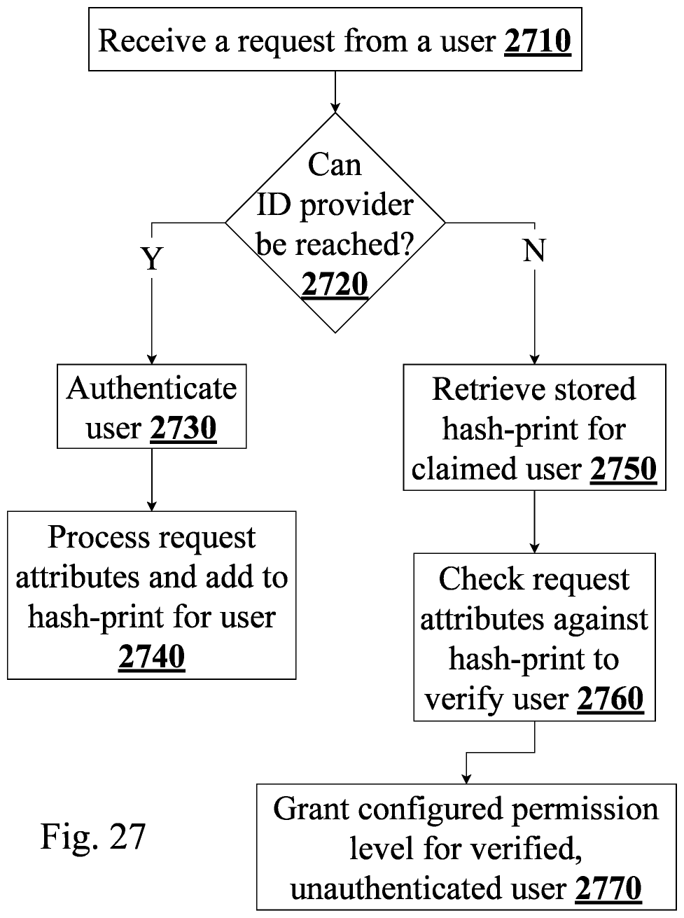

FIG. 27 is a flow diagram illustrating an exemplary method for incorporating hash-print verification with an identity provider, according to one aspect. According to this method, if for any reason an identity provider is unable to issue or verify an authentication object, a user may be authenticated using a stored hash-print as a fallback option to continue normally. This improves the function of features such as single-sign-on, enabling a user to continue with an authenticated session even during times when an identity provider may be offline such as for maintenance or due to network issues; it also enables authenticated access to resources that do not have a direct connection to an authoritative identity provider to authenticate the user and issue an AO, for example when a user connects to a resource outside the identity provider's network. In addition, this method enhances the functionality of a user's hash-print by adding any new attributes to the hash-print when the user successfully authenticates with an identity provider. This ensures that the user's hash-print is kept up-to-date with regard to changes in attributes such as hardware IDs (for example, if the user is authenticating on a new device) or software attributes such as browser or operating system version (for example, if the user has updated software recently).

When a request is received 2710, an attempt is made by the system 910 to reach an identity provider 922 to authenticate the user and issue an AO 2720. If the identity provider can be reached and the user authenticates successfully 2730, any identifying attributes associated with the request may then be hashed by hashing engine 912 and added to the user's stored hash-print 2740 in a database 914, updating the pool of known hash values to reflect any new attributes such as new software versions or device hardware identifiers. This enables users to authenticate and passively update their hash-print with updated information such as new device identifiers or software versions, enabling continuous use of the hash-print for user verification as attributes associated with the user change. If the identity provider cannot be reached, a stored hash-print for the claimed user of the request may be retrieved 2750 from storage, and compared against the current attributes associated with the request 2760 to verify whether the user is who they claim. This may be used to grant a configured level of permissions for verified-but-unauthenticated users 2770, for example a default “public access” form of privilege that allows restricted access to only select resources, or may be used as a fallback for situations where the identity provider may be unavailable, providing the standard privileges to a verified user as though they had authenticated successfully. This enables more flexible authentication without compromising security, by using forgery-resistant hash-prints in lieu of standard session fingerprints that may be more easily forged if an attacker knows what attributes are used to fingerprint a user, and enables seamless sign-on for users regardless of identity provider connectivity issues or downtime.

FIG. 28 is a flow diagram illustrating an exemplary method for verifying a user session based on a randomly-selected subset of authentication characteristics to prevent forgery, according to one aspect. According to this method, when a request is received 2810 a randomized selection of identifying attributes may be selected 2820 for use in authenticating the request. Each selected attributed may be individually hashed 2830 and the hashes checked against a stored hash-print for the user the request claims to be associated with 2840 to determine whether they are present. If any attribute fails this check, the verification fails 2850, preventing an attacker from forging a selection of session attributes in order to impersonate another user. Only when all selected attributes match 2860 is the verification successful, reducing the likelihood of a successful forgery attack as the attributes checked for authentication, and the quantity thereof, may be randomized and thus quickly reveal any forgeries.

These hash-print methods provide a robust fallback authentication scheme for when an identity provider is unavailable, that is highly resistant to forgery attempts as the selection of attributes need not be the same each time and may vary in quantity. This additionally provides a consistent user verification experience when a known user changes network location or device, as the hash-print process may be repeated with additional successful authentication sessions. For example, if a user changes to a new computing device, their session may fail a hash-print verification due to a number of differing attributes such as hardware IDs, browser type or version, operating system type or version, screen size, or other device-specific attributes. When the user successfully authenticates with an identity provider, these new attributes may be processed to add their respective hash values to the user's existing hash-print. Thus, a hash-print may be expanded as needed and encompass any number of hashed identifying attributes, and when a user is verified any available subset of attributes may be checked against the hash-print to authenticate the user. This improves the security of fingerprint-style user and session authentication by preventing forgery (as the selection of attributes may be randomized, preventing an attacker from predicting what attributes should be forged and ensuring an authentication failure if any mismatched attributes are present, which would invalidate the hash result for the incorrect attribute), while also providing improved user verification even as their session details change due to changes of device or network location.

### Exemplary Computing Environment

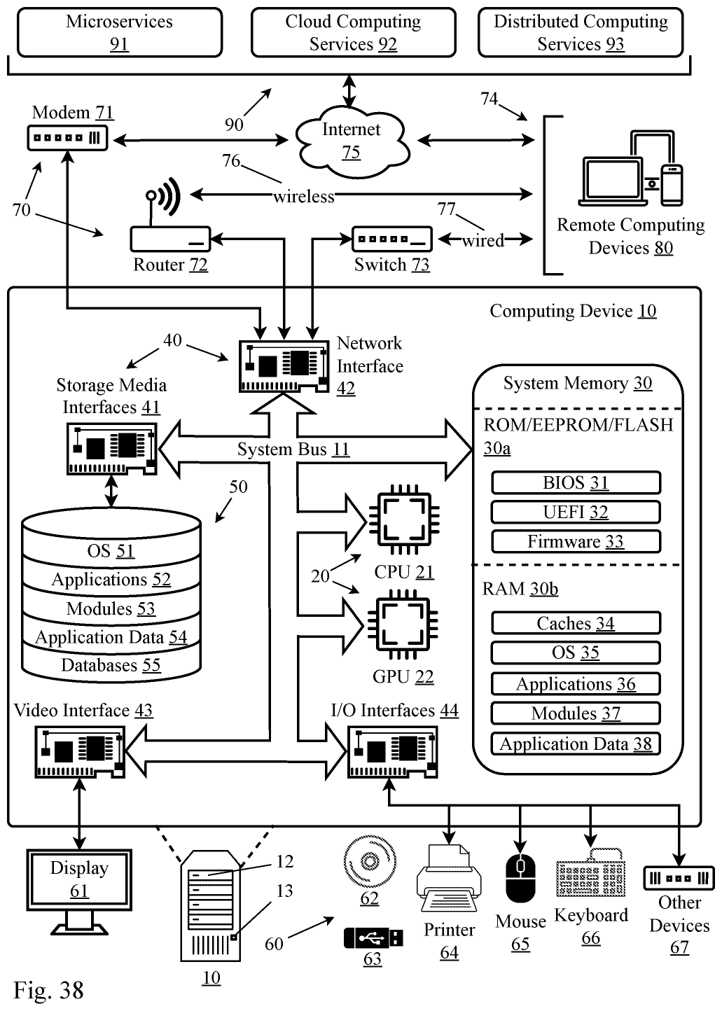

FIG. 38 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between, those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed, or the processing mechanisms employed therein, but are typically comprised of semiconductor materials into which many transistors are formed together into logic gates on a chip (i.e., an integrated circuit or IC). However, the term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable or independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory 30a such as read only memory (ROM), electronically-erasable programmable memory (EEPROM), or rewritable solid state memory (commonly known as “flash memory”). Non-volatile memory 30a is not erased when power to the memory is removed. Non-volatile memory 30a is typically used for long-term storage a basic input/output system (BIOS) 31, containing the basic instructions, typically loaded during computer startup, for transfer of information between components within computing device, unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b such as random access memory (RAM) is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage provide long-term storage of data. Data on non-volatile data storage devices 50 is not erased when power to the non-volatile data storage devices 50 is removed. Non-volatile data storage devices 50 may be implemented using technology for non-volatile storage of content such as CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing 10 as in the case of internal hard drives, removable from computing device 10 as in the case of external USB hard drives, or a combination thereof, but computing device will comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications for providing high-level functionality of computing device 10, program modules 53 such as containerized programs or applications, or other modular content or modular programming, application data 54, and databases 55 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 30 for use) such processes and components may reside or be processed at various times in different components of computing device 10, remote computing devices 80, and/or cloud-based services 90.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services.

Microservices 91 are collections of small, loosely coupled, and independently deployable computing services. Each microservice represents a specific business functionality and runs as a separate process or container. Microservices promote the decomposition of complex applications into smaller, manageable services that can be developed, deployed, and scaled independently. These services communicate with each other through well-defined APIs (Application Programming Interfaces), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. For example, cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for deception-based cybersecurity using distributed sensor nodes, comprising:
a plurality of network traffic sensors each comprising a plurality of programming instructions stored in a memory of, and operating on a processor of, a respective computing device, wherein each plurality of programmable instructions, when operating on the processor, cause the respective computing device to:
monitor visible network traffic;
analyze the traffic to identify a plurality of patterns, wherein the analysis comprises analysis of a plurality of network interactions, commands executed, and attempted exploits;
communicate with at least one other of the plurality of network traffic sensors to correlate the identified plurality of patterns with the respective identified patterns of the at least one other network traffic sensor;
produce a threat landscape, wherein the threat landscape comprises a plurality of identified traffic patterns;
identify a plurality of potential cybersecurity threats based on the threat landscape; and
export the analyzed traffic data and the threat landscape for use by external systems.

2. The system of claim 1, further comprising a network module comprising a second plurality of programming instructions stored in the memory of, and operating on the processor of, the respective computing device, wherein the second plurality of programmable instructions, when operating on the processor, cause the respective computing device to:
receive the traffic, the traffic being associated with a network service;
analyze the traffic to determine a destination network service associated with the traffic;
emulate the destination network service and forward the traffic to the emulated destination network service; and
monitor and log the network interactions.

3. The system of claim 1, further comprising a web module comprising a third plurality of programming instructions stored in the memory of, and operating on the processor of, the respective computing device, wherein the third plurality of programmable instructions, when operating on the processor, cause the respective computing device to:
receive the traffic, the traffic being associated with a web service;
analyze the traffic to determine a destination web service associated with the traffic;
emulate the destination web service and forward the traffic to the emulated destination web service; and
monitor and log web interaction data.

4. The system of claim 1, further comprising an internet-of-things module comprising a fourth plurality of programming instructions stored in the memory of, and operating on the processor of, the respective computing device, wherein the fourth plurality of programmable instructions, when operating on the processor, cause the respective computing device to:
connect to an Internet-of-Things (IoT) device;
determine an IoT protocol or service associated with the IoT device;
emulate the IoT protocol or service; and
monitor and log commands executed and exploits attempted within the emulation.

5. The system of claim 1, further comprising a vulnerability module comprising a fifth plurality of programming instructions stored in the memory of, and operating on the processor of, the respective computing device, wherein the fifth plurality of programmable instructions, when operating on the processor, cause the respective computing device to:
simulate a known vulnerability or weakness to attract an attacker;
receive the traffic, the traffic being associated with the attacker; and
monitor and log commands executed exploits attempted by the attacker as the attacker interacts with simulated vulnerability or weakness.

6. The system of claim 1, wherein the plurality of network interactions, commands executed, and attempted exploits are received from an emulation engine, the emulation engine comprising one or more modules configured to operate as a lightweight honeypot.

7. The system of claim 6, wherein the plurality of network interactions, commands executed, and attempted exploits are logged during monitored interactions between an attacker and an emulated service or emulated application.

8. A method for deception-based cybersecurity using distributed sensor nodes, comprising the steps of:
monitoring, at a network traffic sensor, visible network traffic;
analyzing the traffic to identify a plurality of patterns, wherein the analysis comprises analysis of a plurality of network interactions, commands executed, and attempted exploits;
communicating with at least one other of the plurality of network traffic sensors to correlate the identified plurality of patterns with the respective identified patterns of the at least one other network traffic sensor;
producing a threat landscape, wherein the threat landscape comprises a plurality of identified traffic patterns;
identifying a plurality of potential cybersecurity threats based on the threat landscape; and
exporting the analyzed traffic data and the threat landscape for use by external systems.

9. The method of claim 8, further comprising the steps of:
receiving, at a network module operating on the network traffic sensor, the traffic, the traffic being associated with a network service;
analyzing the traffic to determine a destination network service associated with the traffic;
emulating the destination network service and forwarding the traffic to the emulated destination network service; and
monitoring and logging the network interactions.

10. The method of claim 8, further comprising the steps of:
receiving, at a web module operating on the network traffic sensor, the traffic, the traffic being associated with a web service;
analyzing the traffic to determine a destination web service associated with the traffic;
emulating the destination web service and forwarding the traffic to the emulated destination web service; and
monitoring and logging web interaction data.

11. The method of claim 8, further comprising the steps of:
connecting, using an Internet-of-Things (IoT) module operating on the network traffic sensor, to an IoT device;
determining an IoT protocol or service associated with the IoT device;
emulating the IoT protocol or service; and
monitoring and logging commands executed and exploits attempted within the emulation.

12. The method of claim 8, further comprising the steps of:
simulating, using a vulnerability module operating on the network traffic sensor, a known vulnerability or weakness to attract an attacker;
receiving the traffic, the traffic being associated with the attacker; and
monitoring and logging commands executed and exploits attempted by the attacker as the attacker interacts with simulated vulnerability or weakness.

13. The method of claim 8, wherein the plurality of network interactions, commands executed, and attempted exploits are received from an emulation engine, the emulation engine comprising one or more modules configured to operate as a lightweight honeypot.

14. The method of claim 13, wherein the plurality of network interactions, commands executed, and attempted exploits are logged during monitored interactions between an attacker and an emulated service or emulated application.
